(19) United States
(12) Patent Application Publication
(10) Pub. No.: US 2026/0055004 A1
(43) Pub. Date: Feb. 26, 2026

(54) LEAD OXIDES, COMPOSITIONS COMPRISING LEAD OXIDES AND METHODS OF MAKING LEAD OXIDES

(71) Applicants: Cambridge Enterprise Limited, Cambridge (GB); Ever Resource Limited, Cambridge (GB)

(72) Inventors: Vimalnath SELVARAJ, Cambridge (GB); Rumen TOMOV, Cambridge (GB); Peter KNIGHT, Cambridge (GB); Marcel YIAO, Cambridge (GB); Ramachandran Vasant KUMAR, Cambridge (GB); Athan Lucian FOX, Cambridge (GB)

(21) Appl. No.: 19/107,111

(22) PCT Filed: Aug. 31, 2023
(86) PCT No.: PCT/GB2023/052261

§ 371 Date: Feb. 27, 2025

(30) Foreign Application Priority Data
Aug. 31, 2022 (GB) 2212635.3

(51) Int. Cl. C01G 21/10; C01G 21/02; C01G 21/06; H01M 4/02; H01M 4/14

(52) U.S. Cl. CPC C01G 21/10; C01G 21/02; C01G 21/06; H01M 4/14; C01P 2004/03; C01P 2004/32; C01P 2004/54; C01P 2004/61; C01P 2004/62; C01P 2004/64; C01P 2006/12; C01P 2006/14; C01P 2006/16; C01P 2006/40; H01M 2004/021

(57) ABSTRACT

A composition is provided comprising one or more of alpha lead oxide, beta lead oxide, metallic lead. Pb₂O₃ and Pb₃O₄, the composition comprising particles comprising sub-particles, the sub-particles having a mean greatest dimension of from 10 to 300 nm. Methods of making such a composition are also described.

### BACKGROUND OF THE INVENTION

The present disclosure relates to lead oxides.

The present invention concerns lead oxides (such as alpha lead (II) oxide, beta lead (II) oxide, red lead and Pb₂O₃). More particularly, but not exclusively, this invention concerns methods of making such lead oxides, compositions comprising such lead oxides, battery plates made using such compositions and batteries comprising such battery plates.

Lead oxides are used in the manufacture of lead-acid batteries. Such lead oxides may be obtained by recycling lead-acid batteries. Traditional methods of recycling are energy-intensive, typically involving smelting, which involves heating to high temperatures. WO2008/056125 describes a lower energy method of recovering lead for use in lead-acid batteries, comprising forming lead citrate and then forming a composition comprising lead and/or lead (II) oxide. The composition can then be used to make battery plates, which may be used in lead-acid batteries.

The present invention seeks to mitigate one or more of the above-mentioned problems. Alternatively or additionally, the present invention seeks to provide an improved method of making lead oxides.

### SUMMARY OF THE INVENTION

In accordance with a first aspect of the present invention, there is provided a method of making a composition comprising alpha lead (II) oxide, the method comprising:
converting an organic lead salt into PbOPbCO₃; and
heating said PbOPbCO₃ in a substantially inert atmosphere.

The inventors have discovered that it is possible to make alpha lead (II) oxide by converting an organic lead salt, for example, lead citrate, into a lead (II) oxide, optionally converting lead (II) oxide into PbOPbCO₃; and then heating the PbOPbCO₃. Throughout the entirety of this document, references to “lead oxide” are to be taken to mean lead (II) oxide (PbO), unless the context dictates otherwise.

Alpha lead (II) oxide is often known as litharge and has a tetragonal crystal structure.

The organic lead salt may be anhydrous, or may be partially or fully hydrated. The organic lead salt may comprise a lead carboxylate. The carboxylate may be aliphatic. The carboxylate may be linear or branched. The carboxylate may be saturated or unsaturated. The carboxylate may be an alkyl carboxylate. The carboxylate may comprise at least 2 carbon atoms, optionally at least 3 carbon atoms, optionally at least 4 carbon atoms, optionally at least 5 carbon atoms and optionally at least 6 carbon atoms. The carboxylate may comprise up to 20 carbon atoms, optionally up to 18 carbon atoms, optionally up to 16 carbon atoms, optionally up to 14 carbon atoms, optionally up to 12 carbon atoms, optionally up to 10 carbon atoms, and optionally up to 8 carbon atoms. The carboxylate may comprise from 2 to 15 carbon atoms, optionally from 2 to 12 carbon atoms, optionally from 2 to 8 carbon atoms, and optionally from 2 to 6 carbon atoms.

The organic lead salt may comprise a lead salt of a monocarboxylic acid, such as lead acetate. The monocarboxylic acid may optionally be a saturated acid. The monocarboxylic acid may optionally be a linear or branched acid. The organic lead salt may comprise a lead salt of a dicarboxylic acid, such as glutaric acid. The dicarboxylic acid may optionally be a saturated acid. The dicarboxylic acid may optionally be a linear or branched acid. The organic lead salt may comprise a lead salt of a tricarboxylic acid, such as citric acid. The tricarboxylic acid may optionally be a saturated acid. The tricarboxylic acid may optionally be a branched acid.

The organic lead salt is preferably lead citrate.

For convenience, the term ‘lead citrate’ is used to refer to Pb(C₆H₆O₇) and hydrates thereof, as well as other stoichiometries, e.g. 3Pb·2(C₆H₅O₇), and their hydrates. In some aspects of the invention, the term ‘lead citrate’ is used to refer to Pb(C₆H₆O₇) and hydrates thereof, as well as the product of PbSO₄ treated with aqueous citric acid solution and aqueous trisodium citrate. In further aspects of the invention, the term ‘lead citrate’ is used to refer to Pb(C₆H₆O₇) and hydrates thereof. In particular, ‘lead citrate’ may refer to trilead dicitrate [3Pb·2(C₆H₅O₇)], often known as trilead citrate, and hydrates thereof.

The organic lead salt (such as lead citrate) is optionally provided as particles, optionally in the form of elongate particles and optionally in the form of rod-shaped particles. The particles of the organic lead salt may have a mean greatest dimension of at least 0.5 μm, optionally at least 1.0 μm, optionally at least 1.5 μm and optionally at least 2.0 μm. The particles of the organic lead salt may optionally have a mean greatest dimension of no more than 20 μm, optionally no more than 15 μm and optionally no more than 10 μm. The inventors have discovered that the use of relatively large particles of organic lead salt (particularly lead citrate) is advantageous in the formation of alpha lead (II) oxide. The mean aspect ratio of the particles of organic lead salt may be at least 1.5:1, optionally at least 2.0:1 and optionally at least 3.0:1. The mean aspect ratio of the particles of organic lead salt may optionally be no more than 20:1, optionally no more than 15:1, optionally no more than 10:1, optionally no more than 7.5:1 and optionally no more than 5:1.

Converting an organic lead salt, optionally lead citrate, into PbOPbCO₃ may comprise converting the organic lead salt into a lead (II) oxide, converting said lead (II) oxide into lead carbonate, and converting lead carbonate into PbOPbCO₃. Converting an organic lead salt into a lead (II) oxide may comprise heating an organic lead salt in the presence of an oxidising agent, for example, an oxidising gas, such as a gas comprising oxygen, for example, a gas comprising molecular oxygen, O₂. Converting said lead (II) oxide into lead carbonate may comprise heating said lead (II) oxide in the presence of carbon dioxide. Heating an organic lead salt to form lead (II) oxide and converting said lead (II) oxide into lead carbonate may be performed sequentially and/or simultaneously. For example, heating the organic lead salt to form lead (II) oxide and converting said lead (II) oxide into lead carbonate may be performed by heating lead citrate in the presence of an oxidising agent, such as an oxidising gas (for example, a gas comprising molecular oxygen, O₂) and carbon dioxide. Converting an organic lead salt into lead carbonate may therefore comprise heating the organic lead salt in the presence of an oxidising gas and carbon dioxide. Without wishing to be bound by theory, it is understood that heating of the organic lead salt in the presence of the oxidising agent causes the formation of beta lead (II) oxide. Those skilled in the art will realise that beta lead (II) oxide may not be the sole product formed. The beta lead (II) oxide reacts with the carbon dioxide to form lead carbonate.

Converting lead carbonate into PbOPbCO₃ may comprise heating lead carbonate. Heating lead carbonate optionally causes the formation of lead oxide (optionally alpha lead oxide). The lead oxide may react with lead carbonate to form PbOPbCO₃. For the avoidance of doubt, the conversion of lead carbonate to form lead oxide may be a reversible process. Lead carbonate, when heated, may form lead oxide and carbon dioxide. Lead oxide and carbon dioxide may react to form lead carbonate.

If the oxidising agent comprises a gas (for example, a gas comprising molecular oxygen, O₂), the oxidising agent may be provided as a flow of gas. The method may comprise contacting the lead citrate with a flow of said oxidising agent.

The carbon dioxide may be provided as a flow of carbon dioxide. The method may comprise contacting the lead (II) oxide with a flow of carbon dioxide.

If the oxidising agent comprises molecular oxygen (for example, if air is used as an oxidising agent) and if forming the lead carbonate comprises heating the lead (II) oxide in the presence of carbon dioxide, then the molar ratio of carbon dioxide to molecular oxygen may optionally be at least 10:1, optionally at least 12:1, optionally at least 15:1, optionally at least 18:1, optionally at least 20:1, optionally at least 25:1, optionally at least 30:1, optionally at least 40:1 and optionally at least 50:1. The inventors have discovered that a molar ratio of carbon dioxide to molecular oxygen of at least 25:1 may be beneficial because the amount of alpha lead oxide in the final composition is significantly greater than at a molar ratio of 12:1. The inventors have also discovered that a molar ratio of carbon dioxide to molecular oxygen of at least 50:1 may be beneficial because the amount of alpha lead oxide in the composition is significantly greater than at a molar ratio of 40:1. For the avoidance of doubt, if air is used to provide the molecular oxygen, then the amount of molecular oxygen may be determined based on air comprising 21% oxygen. The inventors have discovered that a relatively high ratio of carbon dioxide to molecular oxygen is effective in producing a high percentage of alpha lead oxide in the composition, particularly if organic lead salt (for example, lead citrate) is heated in a mixture of a gas comprising molecular oxygen (such as air) and carbon dioxide.

The molar ratio of carbon dioxide to molecular oxygen may optionally be no more than 250:1, optionally no more than 200:1, optionally no more than 150:1, and optionally no more than 100:1.

The PbOPbCO₃ is heated in a substantially inert atmosphere (for example, in nitrogen) to form alpha lead (II) oxide. The PbOPbCO₃ may be heated for a sufficiently long time to form alpha lead (II) oxide. The PbOPbCO₃ may optionally be heated for at least 5 minutes, optionally at least 10 minutes, optionally at least 20 minutes and optionally at least 30 minutes. The PbOPbCO₃ may optionally be heated for no more than 120 minutes, optionally no more than 90 minutes, optionally no more than 75 minutes and optionally no more than 60 minutes. It has been found that in order to produce a relatively large amount of alpha lead (II) oxide, the PbOPbCO₃ has to be heated for a sufficient time.

The PbOPbCO₃ may be heated at a sufficiently high temperature to facilitate formation of alpha lead (II) oxide. The PbOPbCO₃ may be heated at a temperature of at least 250° C., optionally at least 275° C., optionally at least 300° C. and optionally at least 325° C. The PbOPbCO₃ may optionally be heated at no more than 450° C., optionally no more than 425° C., optionally no more than 400° C. and optionally no more than 375° C.

The PbOPbCO₃ may be heated at a temperature of from 300° C. to 400° C., optionally of from 325° C. to 375° C., optionally for a duration of 10 to 90 minutes, optionally for a duration of 20 to 60 minutes and optionally for a duration of about 30 minutes.

Those skilled in the art will realise that the method of the present invention need not yield only alpha lead oxide, and that the composition may comprise other components, such as one or more of beta lead oxide, lead metal, lead oxide carbonate, lead carbonate, red lead and carbon. However, the method of the present invention may yield a composition comprising at least 20 wt % alpha lead oxide, optionally at least 30 wt % alpha lead oxide, optionally at least 40 wt % alpha lead oxide, optionally at least 50 wt % alpha lead oxide, optionally at least 60 wt % alpha lead oxide, optionally at least 70 wt % alpha lead oxide, optionally at least 80 wt % alpha lead oxide, optionally at least 90 wt % alpha lead oxide, optionally at least 95 wt %, and optionally at least 98 wt % alpha lead oxide. The alpha lead oxide content may be measured, for example, using acid dissolution or by x-ray diffraction, as will now be described.

A sample of a composition was homogenised using pestle and mortar. The homogenised samples were characterised using a B3 (BB) Bruker D8 DAVINCI on Gen 9 (Bruker D8 Advance, USA) in the 20 range from 10° to 90°, with Cu-Kα radiation (λ=1.5406 A) having a step size of 0.0300° 2θ, scan step of 96.00 s (total steps of 2628) and 0.5 s per step at 40 mA and 40 kV. The diffraction data were background-corrected and analysed using “Highscore” data analysis software (Bruker-Pan Analytica) using library data for the target materials to identify the materials present and the relative amounts of those materials. This information was used to calculate the relative proportions of alpha lead oxide and beta lead oxide in the composition. One limitation of using x-ray diffraction is that if one particular material is dominant (for example, lead oxide), diffraction peaks from other materials may be difficult to identify and/or quantify. X-ray diffraction may also be used to identify and/or quantify other oxides of lead, such as Pb₂O₃ and Pb₃O₄. However, it may be difficult to identify and/or quantify materials that are present in an amount of about 10 wt % or less.

Acid dissolution may be used to determine the relative amounts of various components in the composition. 2 g of a composition was contacted with 50 mL of 5% aqueous acetic acid in a 250 mL Erlenmeyer flask, the suspension being stirred for 5 min using a magnetic stirrer at 500 rpm. Any lead oxide was dissolved in the acetic acid, leaving one or more of metallic lead, carbon, red lead and Pb₂O₃ undissolved. Whether or not the undissolved material floats depends, to some extent, on particle size, density of the material and particle charge. Denser material has a tendency to settle. However, very small particles have a tendency to remain in suspension. It is therefore possible for small particles of inherently dense material to float. Generally, however, carbon and metallic lead (sometimes coated with carbon) settle at the bottom of the flask, while red lead and Pb₂O₃ remains in suspension.

The suspension or solution was decanted from the solid material, if any, settled at the bottom of the flask.

If the settled contents showed any black colouration, then this indicated the presence of carbon. The settled contents were washed with water and dried in order to determine the weight of the settled contents. The settled contents were then washed with water to facilitate the separation by density differential of carbon from the metallic lead. The settled contents were washed to facilitate separation until the heavier solid portion showed no further black colouration, indicating that the heavier solid proportion was metallic lead. The metallic lead was then dried. The weight of the metallic lead could then be determined. The weight of the carbon could also be determined. The proportion of metallic lead and carbon in the composition could also be determined.

If the suspension in the flask appeared red-orange, then this indicated the presence of red lead. The suspension was filtered, and the residue washed with Milli-Q high purity water and dried. The weight of the red lead could then be determined from the weight of the residue and the proportion of red lead in the composition could also be determined.

If the suspension in the flask appeared brown, then this indicated the presence of Pb₂O₃. The wt % of Pb₂O₃ was determined by reference to the x-ray diffraction data, as described above.

As mentioned above, alpha and beta lead oxide are dissolved in the acid, forming lead acetate. Solvent may be removed to yield lead acetate, which may be used to calculate the total amount of alpha and beta lead oxide in the sample. X-ray diffraction data were used to determine the relative amounts of alpha lead oxide and beta lead oxide in the original sample prior to acid dissolution, and the relative amounts of alpha and beta lead oxide as determined by x-ray diffraction were used to calculate the amounts of the alpha and beta lead oxide in the composition.

The method of the first aspect of the present invention may be performed in a rotary furnace.

As mentioned above, the method of the first aspect of the present invention is used to make a composition comprising alpha lead oxide. In accordance with a second aspect of the present invention, there is provided a composition comprising alpha lead oxide, the composition being producible, or produced, by the method of the first aspect of the present invention. The composition may comprise those parameters described above in relation to the method of the first aspect of the present invention. The composition may, for example, comprise at least 80 wt % alpha lead oxide, optionally at least 85 wt % alpha lead oxide, optionally at least 90 wt % alpha lead oxide, optionally at least 95 wt % alpha lead oxide, optionally at least 98 wt % alpha lead oxide and may optionally consist essentially of alpha lead oxide. The composition may comprise metallic lead.

The composition may comprise particles. The composition may comprise rod-like particles. The composition may comprise amorphous particles (i.e. particles without a clearly defined shape). The composition may comprise particles with apertures and/or channels therein. Such particles may have a structure with a network of apertures and/or channels therein. Particles may comprise sub-particles. The sub-particles are smaller than the particles. At least some of the sub-particles may optionally be in the form of projections. The particles may optionally have a mean greatest dimension of from 0.2 μm to 20 μm. The sub-particles may optionally have a mean greatest dimension of at least 10 nm, optionally at least 15 nm, optionally at least 20 nm, optionally at least 25 nm, optionally at least 30 nm, optionally at least 40 nm and optionally at least 50 nm. The sub-particles may have a mean greatest dimension of no more than 300 nm, optionally of no more than 250 nm, optionally of no more than 200 nm, optionally of no more than 150 nm and optionally of no more than 100 nm. The sub-particles may have a mean greatest dimension of from 10 to 300 nm, optionally of from 15 nm to 200 nm and optionally of from 20 nm to 150 nm. The sub-particles may be spherical or sub-spherical. The sub-particles may or may not have the same chemical composition as the other parts of the particles.

The inventors have discovered that compositions comprising lead-based materials that may be of use in the battery industry have advantageous properties (in particular, relatively high surface area) if the composition comprises relatively large particles on which are formed relatively small sub-particles which may be in the form of projections.

The dimensions of the particles and the sub-particles may be measured using any suitable method, such as scanning electron microscopy.

Optionally, at least 20% by number of the particles of the composition are rod-like particles. Optionally, at least 40%, optionally at least 50%, optionally at least 60%, optionally at least 70%, optionally at least 80%, optionally at least 90% and optionally at least 95% by number of the particles of the composition are rod-like.

Optionally, of the rod-like particles, optionally at least 50% by number have a greatest dimension of from 0.2 μm to 20 μm, optionally at least 60%, optionally at least 70%, optionally at least 80% and optionally at least 90% by number have a greatest dimension of from 0.2 μm to 20 μm.

As mentioned above, the composition optionally comprises rod-like particles. The mean aspect ratio of the rod-like particles may be at least 1.5:1, optionally at least 2.0:1 and optionally at least 3.0:1. The mean aspect ratio of the rod-like particles may be no more than 20:1, optionally no more than 15:1, optionally no more than 10:1, optionally no more than 7.5:1 and optionally no more than 5:1.

Optionally, of the rod-like particles, optionally at least 50% by number, optionally at least 60%, optionally at least 70%, optionally at least 80% and optionally at least 90% by number have an aspect ratio of at least 1.5:1, optionally at least 2.0:1 and optionally at least 3.0:1. Optionally at least 50% by number, optionally at least 60%, optionally at least 70%, optionally at least 80% and optionally at least 90% by number have an aspect ratio of no more than 20:1, optionally no more than 15:1, optionally no more than 10:1, optionally no more than 7.5:1 and optionally no more than 5:1.

The composition may comprise particles with a lead metal-rich and oxide-poor core portion, and an oxide-rich outer portion. The inventors have discovered that some particles have a core that is rich in lead metal and has a low content of oxides of lead, and an outer portion that is rich in oxides of lead. Such an arrangement may be favourable because the outer portion effectively protects the core portion from oxidation in the event that the composition is exposed to air. Without wishing to be bound by theory, it is anticipated that batteries made from such a composition may have an enhanced cycle life because the outer portion protects the core portion from sulfation.

The core portion may comprise at least 95 wt % lead metal, optionally at least 96 wt % lead metal and optionally at least 98 wt % lead metal. The core portion may be substantially devoid of lead oxides.

The outer portion may comprise one or more of alpha lead oxide, beta lead oxide, red lead and Pb₂O₃.

The core portion may be spherical or sub-spherical.

The volume of the core portion is optionally greater than the volume of the outer portion. The volume of the core portion is optionally at least two times, optionally at least three times, optionally at least five times, optionally at least ten times, optionally at least fifteen times, optionally at least twenty times, optionally at least thirty times, optionally at least forty times, optionally at least fifty times and optionally at least one hundred times the volume of the outer portion.

The core portion may have a mean greatest dimension of at least 1 μm, optionally at least 2 μm, optionally at least 5 μm and optionally at least 10 μm. The core portion may optionally have a mean greatest dimension of no more than 100 μm, optionally no more than 80 μm, optionally no more than 60 μm, optionally no more than 50 μm, optionally no more than 40 μm and optionally no more than 30 μm.

The BET surface area (optionally determined using nitrogen, optionally at 77 K) of the composition is optionally at least 1.0 m²/g, optionally at least 1.5 m²/g, optionally at least 1.8 m²/g, optionally at least 2.0 m²/g, optionally at least 2.5 m²/g and optionally at least 3.0 m²/g. The BET surface area (optionally determined using nitrogen, optionally at 77 K) is optionally no more than 10 m²/g, optionally no more than 8 m²/g, optionally no more than 6 m²/g and optionally no more than 5 m²/g.

The data acquired to determine BET surface area may also be used to determine pore volume. In this connection, the pore volume as determined by BJH analysis (optionally using nitrogen, optionally at 77 K) is optionally at least 0.0050 cm³g⁻¹, optionally at least 0.0060 cm³g⁻¹ and optionally at least 0.0070 cm³g⁻¹. The pore volume as determined by BJH analysis is optionally no more than 0.025 cm³g⁻¹, optionally no more than 0.020 cm³g⁻¹, optionally no more than 0.015 cm³g⁻¹, optionally no more than 0.010 cm³g⁻¹, optionally no more than at least 0.0080 cm³g⁻¹ and optionally no more than 0.0070 cm³g⁻¹.

The pore diameter of the composition as determined by adsorption measurement may optionally be at least 150 Å, optionally at least 175 Å, optionally at least 200 Å, optionally at least 225 Å, optionally at least 250 Å, optionally at least 275 Å and optionally at least 300 Å. The pore diameter as determined by adsorption measurement may optionally be no more than 400 Å, optionally no more than 375 Å, optionally no more than 350 Å, optionally no more than 325 Å, optionally no more than 300 Å, optionally no more than 275 Å, optionally no more than 250 Å, optionally no more than 225 Å and optionally no more than 200 Å.

The acid absorption of the composition may optionally be at least 200 mg acid per g of sample, optionally at least 220 mg acid per g of sample and optionally at least 240 mg acid per g of sample. The acid absorption may optionally be no more than 1000 mg acid per g of sample, optionally no more than 800 mg acid per g of sample, optionally no more than 600 mg acid per g of sample, optionally no more than 500 mg acid per g of sample, optionally no more than 400 mg acid per g of sample, optionally no more than 350 mg acid per g of sample, optionally no more than 300 mg acid per g sample and optionally no more than 280 mg acid per g of sample. Acid absorption may be determined using sulphuric acid, for example, 16 wt % sulphuric acid. For the avoidance of doubt, it is common for the terms “acid absorption” and “acid adsorption” to be used interchangeably in this technical field.

In accordance with a third aspect of the present invention, there is also provided a method of making a composition comprising beta lead (II) oxide, the method comprising heating an organic lead salt in a flow of a gas comprising an oxidising agent.

The inventors have unexpectedly discovered that by contacting an organic lead salt (such as lead citrate) with a flow of a gas comprising an oxidising agent it is possible to better control the production of beta lead (II) oxide.

Beta lead oxide is often known as massicot and has an orthorhombic structure that can be readily identified using x-ray diffraction.

The gas comprising an oxidising agent typically comprises an inert diluent. For example, the gas may comprise air, which comprises an oxidising agent in the form of molecular oxygen gas and an inert diluent in the form of nitrogen gas. It has been discovered that the presence of an inert diluent is advantageous in the formation of beta lead oxide. While air comprises inert diluent in the form of nitrogen gas, the inventors have found that it may be beneficial to further reduce the concentration of oxidising agent. The method may therefore comprise mixing a precursor gas comprising the oxidising agent with a diluent gas to provide the gas comprising the oxidising agent. The precursor gas may comprise air, for example. The diluent gas may be an inert diluent and may comprise nitrogen, for example. The molar ratio of the diluent gas to the precursor gas (particularly if the precursor gas is air) may be at least 1:10, optionally at least 1:5, optionally at least 1:2.5, optionally at least 1:2 and optionally at least 1:1.5. The molar ratio of the diluent gas to the precursor gas may optionally be no more than 5:1, optionally no more than 4:1, optionally no more than 3:1 and optionally no more than 2:1. The molar ratio of the diluent gas to the precursor gas may be from 1:10 to 5:1, optionally from 1:5 to 3:1 and optionally from 1:2 to 2:1. The use of a diluent gas to dilute the oxidising agent reduces the concentration of the oxidising agent, which reduces the temperature rise associated with the exothermic reaction of the oxidising agent with the lead citrate. At high temperatures, the formation of metallic lead is promoted. At lower temperatures, the formation of beta lead oxide is favoured.

If the oxidising agent is in the form of a gaseous oxidising agent, such as molecular oxygen, then the gas optionally comprises no more than 20 wt % oxidising agent, optionally no more than 18 wt % oxidising agent, optionally no more than 16 wt % oxidising agent, optionally no more than 14 wt % oxidising agent, optionally no more than 12 wt % oxidising agent and optionally no more than 10 wt % oxidising agent.

If the oxidising agent is in the form of a gaseous oxidising agent, such as molecular oxygen, then the gas optionally comprises at least 1 wt % oxidising agent, optionally at least 2 wt % oxidising agent, optionally at least 3 wt % oxidising agent, optionally at least 5 wt % oxidising agent, optionally at least 7.5 wt % oxidising agent and optionally at least 10 wt % oxidising agent.

If the oxidising agent is in the form of a gaseous oxidising agent, such as molecular oxygen, then the gas optionally comprises 1-20 wt % oxidising agent, optionally 1-18 wt % oxidising agent, optionally 3-16 wt % oxidising agent and optionally 5-14 wt % oxidising agent.

While exposed to the flow of gas, the organic lead salt may be heated to a temperature of at least 250° C., optionally at least 275° C., optionally at least 300° C. and optionally at least 325° C. The lead carbonate may optionally be heated at no more than 450° C., optionally no more than 425° C., optionally no more than 400° C. and optionally no more than 375° C.

While exposed to the flow of gas, the organic lead salt may optionally be heated for no more than 240 minutes, optionally no more than 180 minutes, optionally no more than 150 minutes, optionally no more than 120 minutes, optionally no more than 90 minutes, optionally no more than 75 minutes and optionally no more than 60 minutes. While exposed to the flow of gas, the organic lead salt may optionally be heated for at least 30 minutes, optionally at least 60 minutes and optionally at least 90 minutes. Those skilled in the art will realise that the heating time may depend on both the amount of organic lead salt and the volume of the reaction chamber/furnace. In this connection, larger amounts of organic lead salt are associated with longer heating times.

While exposed to the flow of gas, the organic lead salt may be heated to a temperature of from 275° C. to 375° C. for a duration of from 60-180 minutes, optionally of from 90-150 minutes.

The inventors have discovered that it is possible to tailor the composition by changing the method used to make the composition. For example, the inventors have discovered that it is possible to obtain a composition comprising a high percentage of beta lead oxide (for example, at least 80 wt %, optionally at least 85 wt % and optionally at least 90 wt % beta lead oxide) by heating the organic lead salt (particularly lead citrate) at a temperature of 325-375° C. in the presence of a flow of gas comprising a relatively low concentration of oxidising agent (for example, 6-10 wt %, such as may be achieved by mixing a half or 1 volume of air with 1 volume of nitrogen). Heating to higher temperatures (for example, 400° C.) and/or the use of higher proportions of oxidising agent (for example, 13 wt %, such as may be achieved by mixing two volumes of air with one volume of nitrogen) may also provide relatively high proportions of beta lead oxide (optionally at least 70 wt %, optionally at least 75 wt %, optionally at least 80 wt % and optionally at least 85 wt % beta lead oxide), but with a higher proportion of lead metal (optionally at least 5 wt %, optionally at least 6 wt %, optionally at least 7 wt % and optionally at least 8 wt %). This is important because the presence of lead metal in a composition is useful for the preparation of lead battery products. Heating to lower temperatures (for example, 300-325° C.) and/or the use of higher proportions of oxidising agent (for example, 13 wt %, such as may be achieved by mixing two volumes of air with one volume of nitrogen) may also provide relatively high proportions of beta lead oxide (optionally at least 70 wt %, optionally at least 75 wt %, optionally at least 80 wt % and optionally at least 85 wt % beta lead oxide), but with a lower proportion of lead metal (optionally no more than 5 wt %, optionally no more than 3 wt % and optionally no more than 1 wt %), and a proportion of alpha lead oxide (for example, at least 1 wt %, optionally at least 3 wt % and optionally at least 5 wt %).

Those skilled in the art will realise that the method of the present invention need not yield only beta lead oxide, and components other than beta lead oxide may be present in the composition, for example, one or more of alpha lead oxide, lead metal, red lead and carbon may be present. However, the method of the present invention may yield a composition comprising at least 60 wt % beta lead oxide, optionally at least 70 wt % beta lead oxide, optionally at least 80 wt % beta lead oxide and optionally at least 90 wt % beta lead oxide. The beta lead oxide content may be measured, for example, using acid dissolution or by x-ray diffraction.

The organic lead salt may be as defined above in relation to the method of the first aspect of the present invention.

The method of the third aspect of the present invention may be performed in a rotary furnace.

As described above, the method of the third aspect of the present invention is used to produce a composition comprising beta lead oxide. In accordance with a fourth aspect of the present invention, there is therefore provided a composition comprising beta lead oxide, the composition being producible, or produced by, a method in accordance with the third aspect of the present invention. The composition may, for example, comprise at least 85 wt % and optionally at least 90 wt % beta lead oxide. The composition of the fourth aspect of the present invention may comprise any of the features described above in relation to the method of the third aspect of the present invention. The composition may comprise metallic lead.

The composition of the fourth aspect of the present invention may comprise those features described above in relation to the composition of the second aspect of the present invention. For example, the composition of the fourth aspect of the present invention may comprise optionally particles comprising sub-particles. The sub-particles may be projections.

In accordance with a fifth aspect of the present invention, there is provided a method of making a composition comprising red lead, the method comprising:
Converting an organic lead salt into PbOPbCO₃; and
Converting PbOPbCO₃ into red lead.

Red lead is well-known to those skilled in the art. Red lead has the general formula Pb₃O₄, and is also known as lead tetroxide, minium and lead (II, IV) oxide.

Converting an organic lead salt, optionally lead citrate, into PbOPbCO₃ may optionally comprise converting said organic lead salt, optionally lead citrate, into a lead (II) oxide, optionally converting said lead (II) oxide into lead carbonate. The lead carbonate may be heated to form alpha lead oxide. The alpha lead oxide may react with lead carbonate to form PbOPbCO₃. Converting the organic lead salt into said lead (II) oxide may comprise heating the organic lead salt in the presence of an oxidising agent, for example, an oxidising gas, such as a gas comprising oxygen, for example, a gas comprising molecular oxygen, O₂. Converting said lead (II) oxide into lead carbonate may comprise heating said lead (II) oxide in the presence of carbon dioxide. Heating the organic lead salt to form lead (II) oxide and converting said lead (II) oxide into lead carbonate may be performed sequentially and/or simultaneously. For example, heating the organic lead salt to form lead (II) oxide and converting said lead (II) oxide into lead carbonate may be performed by heating the organic lead salt in the presence of an oxidising agent, such as an oxidising gas (for example, a gas comprising molecular oxygen, O₂) and carbon dioxide. Converting the organic lead salt into lead carbonate may therefore comprise heating the organic lead salt in the presence of an oxidising gas and carbon dioxide. Without wishing to be bound by theory, it is understood that heating of the organic lead salt in the presence of the oxidising agent causes the formation of beta lead (II) oxide. Those skilled in the art will realise that beta lead (II) oxide may not be the sole product formed. The beta lead (II) oxide reacts with the carbon dioxide to form lead carbonate.

If the oxidising agent comprises a gas (for example, a gas comprising molecular oxygen), the oxidising agent may be provided as a flow of gas. The method may comprise contacting the organic lead salt with a flow of said oxidising agent.

The carbon dioxide may be provided as a flow of carbon dioxide. The method may comprise contacting the lead (II) oxide with a flow of carbon dioxide.

If the oxidising agent comprises molecular oxygen (for example, if air is used as an oxidising agent) and if forming the lead carbonate comprises heating the lead (II) oxide in the presence of carbon dioxide, then the molar ratio of carbon dioxide to molecular oxygen may optionally be at least 10:1, optionally at least 12:1, optionally at least 15:1, optionally at least 18:1, optionally at least 20:1 and optionally at least 25:1. For the avoidance of doubt, if air is used to provide the molecular oxygen, then the amount of molecular oxygen may be determined based on air comprising 21% oxygen. The inventors have discovered that a relatively high ratio of carbon dioxide to molecular oxygen is effective is producing a high percentage of alpha lead oxide, particularly if lead citrate is heated in a mixture of a gas comprising molecular oxygen (such as air) and carbon dioxide.

The molar ratio of carbon dioxide to molecular oxygen may optionally be no more than 250:1, optionally no more than 200:1, optionally no more than 150:1 and optionally no more than 100:1.

Converting PbOPbCO₃ into red lead may optionally comprise converting PbOPbCO₃ into alpha lead oxide and converting alpha lead oxide into red lead. Converting PbOPbCO₃ into alpha lead oxide may comprise heating PbOPbCO₃ in the presence of a flow of gas, optionally a gas comprising an oxidiser, such as O₂. While the oxidiser does not react with the PbOPbCO₃, the flow of gas removes carbon dioxide that would otherwise react with the alpha lead oxide. Converting alpha lead oxide into red lead may comprise heating alpha lead oxide in the presence of an oxidiser, optionally an oxidising gas, such as a gas comprising molecular oxygen (O₂), such as air.

Converting PbOPbCO₃ into red lead may comprise heating the PbOPbCO₃ at a sufficiently high temperature to facilitate formation of red lead. The PbOPbCO₃ may be heated at a temperature of at least 325° C., optionally at least 350° C., optionally at least 375° C., optionally at least 400° C. and optionally at least 425° C. The applicants have found that the formation of red lead is promoted by heating to relatively high temperatures.

The PbOPbCO₃ may optionally be heated at a temperature of no more than 500° C., optionally no more than 475° C., optionally no more than 450° C. and optionally no more than 425° C.

The PbOPbCO; may be heated for a sufficiently long time to facilitate the formation of red lead. For example, the PbOPbCO₃ may be heated for at least 30 minutes, optionally at least 45 minutes and optionally at least 60 minutes. The applicants have discovered that the formation of red lead is relatively slow, and requires prolonged heating, the duration being dependent somewhat on the temperature.

The PbOPbCO₃ may be heated at a temperature of from 350° C. to 400° C., optionally of from 375° C. to 425° C., optionally for a duration of 30 to 90 minutes and optionally for a duration of 60 to 90 minutes.

The method may be performed in a rotary furnace.

The organic lead salt may be as defined above in relation to the method of the first aspect of the present invention.

Those skilled in the art will realise that the method of the present invention need not yield only red lead, and components other than red lead may be present. For example, one or more of alpha lead oxide, beta lead oxide, lead metal and Pb₂O₃ may be present. However, the method of the present invention may yield a composition comprising at least 50 wt % red lead, optionally at least 60 wt % red lead, optionally at least 70 wt % red lead, optionally at least 80 wt % red lead, optionally at least 90 wt % red lead, optionally at least 95 wt %, and optionally at least 98 wt % red lead. The red lead content may be measured, for example, using acid dissolution or by x-ray diffraction, as described above.

As described above, the method of the fifth aspect of the present invention may be used to produce a composition comprising red lead. In accordance with a sixth aspect of the present invention, there is provided a composition comprising red lead, the composition being producible, or produced by, a method in accordance with the fifth aspect of the present invention. The composition may therefore comprise any of the features described above in relation to the method of the fifth aspect of the present invention. The composition may, for example, comprise at least 85 wt % and optionally at least 90 wt % red lead.

The composition of the sixth aspect of the present invention may comprise those features described above in relation to the composition of the second aspect of the present invention. For example, the composition of the sixth aspect of the present invention may optionally comprise particles comprising sub-particles. The sub-particles may be projections, for example.

In accordance with a seventh aspect of the present invention, there is provided a method of making a composition comprising Pb₂O₃, the method comprising:
Converting an organic lead salt into PbOPbCO₃; and
Converting PbOPbCO₃ into Pb₂O₃.

Pb₂O₃ (or lead sesquioxide) is well-known to those skilled in the art.

Converting an organic lead salt into PbOPbCO₃ may comprise those features described above in relation to the method of forming red lead in accordance with the fifth aspect of the present invention.

Converting PbOPbCO₃ into Pb₂O₃ may optionally comprise converting PbOPbCO₃ into alpha lead oxide and converting alpha lead oxide into Pb₂O₃. Converting PbOPbCO₃ into alpha lead oxide may comprise heating PbOPbCO₃ in the presence of a flow of gas, optionally a gas comprising an oxidiser, such as O₂. While the oxidiser does not react with the PbOPbCO₃, the flow of gas removes carbon dioxide that would otherwise react with the alpha lead oxide. Converting alpha lead oxide into Pb₂O₃ may comprise heating alpha lead oxide in the presence of an oxidiser, optionally an oxidising gas, such as a gas comprising molecular oxygen (O₂), such as air. While the general method of converting PbOPbCO₃ into Pb₂O₃ is similar to that for converting PbOPbCO₃ into red lead, lower temperatures are used to obtain Pb₂O₃ than are used to obtain red lead.

The PbOPbCO₃ may be heated at a sufficiently high temperature in the presence of the oxidising agent to facilitate formation of Pb₂O₃. The PbOPbCO₃ may be heated to a temperature of at least 275° C., optionally at least 300° C., optionally at least 325° C. and optionally at least 350° C. However, too high a temperature promotes the formation of red lead, and therefore it is preferred that the lead carbonate may be heated to a temperature of no more than 400° C., optionally no more than 375° C., optionally no more than 350° C. and optionally no more than 325° C.

The PbOPbCO₃ may be heated for at least 30 minutes, optionally at least 45 minutes, optionally at least 60 minutes and optionally at least 90 minutes. The PbOPbCO₃ may be heated for no more than 300 minutes, optionally no more than 240 minutes, optionally no more than 180 minutes, optionally no more than 150 minutes, optionally no more than 120 minutes and optionally no more than 90 minutes. The applicants have discovered that the formation of Pb₂O₃ is relatively slow, especially at the lower temperatures that are preferred to inhibit the formation of red lead.

The PbOPbCO₃ may be heated at a temperature of from 275° C. to 350° C., optionally of from 275° C. to 325° C., optionally for a duration of 30 to 180 minutes and optionally for a duration of 60 to 120 minutes.

The method may be performed in a rotary furnace.

The organic lead salt may be as defined in relation to the method of the first aspect of the present invention.

Those skilled in the art will realise that the method of the present invention need not yield only Pb₂O₃, and components other than Pb₂O₃ may be present. For example, one or more of alpha lead oxide, beta lead oxide, lead metal and red lead may be present. In particular, alpha lead oxide and/or red lead may be present. However, the method of the present invention may yield a composition comprising at least 40 wt % Pb₂O₃, optionally at least 50 wt % Pb₂O₃ and optionally at least 60 wt % Pb₂O₃. The Pb₂O₃ content may be measured, for example, using acid dissolution and by x-ray diffraction, as described above.

As described above, the method of the seventh aspect of the present invention may be used to produce a composition comprising Pb₂O₃. In accordance with an eighth aspect of the present invention, there is provided a composition comprising Pb₂O₃, the composition being producible, or produced by, a method in accordance with the seventh aspect of the present invention. The composition may comprise those features described above in relation to the method of the sixth aspect of the present invention. The composition may, for example, comprise at least 40 wt % and optionally at least 60 wt % Pb₂O₃.

The composition of the eighth aspect of the present invention may comprise those features described above in relation to the composition of the second aspect of the present invention. For example, the composition of the eighth aspect of the present invention may optionally comprise particles comprising sub-particles. The sub-particles may be projections, for example.

In accordance with a ninth aspect of the present invention, there is provided a method of producing a composition comprising a desired one or more of alpha lead oxide, beta lead oxide, Pb₂O₃, red lead and lead metal, the method comprising:
Determining which of alpha lead oxide, beta lead oxide, Pb₂O₃, red lead and lead metal is or are desired in the composition;
Based on said determination, selecting one or more reaction parameters from the list consisting of one or more heating temperatures, one or more heating durations and one or more gas compositions;
Heating an organic lead salt in accordance with the one or more selected reaction parameters, thereby forming said composition comprising the desired one or more of alpha lead oxide, beta lead oxide, Pb₂O₃, red lead and lead metal.

The inventors have discovered that it is possible to control the components in a lead-containing composition, primarily by controlling the gas composition, in which an organic lead salt is heated.

The method may comprise determining that alpha lead oxide is desired, and the selection of one or more reaction parameters comprises selecting a first gas composition comprising carbon dioxide and an oxidising agent, preferably containing molecular oxygen. The selection of one or more reaction parameters optionally comprises selecting a second gas composition, the second gas composition comprising an inert gas. The method may comprise heating an organic lead salt in the presence of the first gas composition. The method may comprise subsequent heating in the presence of the second gas composition. The method of the ninth aspect of the present invention may comprise features of the method of producing alpha lead oxide as described in accordance with the first aspect of the present invention.

The method may comprise determining that beta lead oxide is desired, and the selection of one or more reaction parameters comprises selecting a gas composition comprising an oxidising agent, preferably containing molecular oxygen, optionally comprising air. The gas composition may comprise an oxidising agent and an inert diluent. The method may comprise mixing a gas comprising an oxidising agent with an inert diluent. The method may comprise heating an organic lead salt in the presence of the gas composition, optionally in a flow of the gas composition. The method of the ninth aspect of the present invention may comprise features of the method of producing beta lead oxide as described in accordance with the third aspect of the present invention.

The method may comprise determining that red lead is desired, and the selection of one or more reaction parameters comprises selecting a first gas composition comprising carbon dioxide and an oxidising agent, preferably containing molecular oxygen. The selection of one or more reaction parameters optionally comprises selecting a second gas composition, the second gas composition comprising an oxidising agent, such as O₂, and optionally excluding carbon dioxide. The selection of one or more reaction parameters may comprise selecting a temperature at which the second gas composition will contact the reagents. The temperature is optionally at least 350° C. and optionally at least 375° C. The method may comprise heating an organic lead salt in the presence of the first gas composition. The method may comprise subsequent heating in the presence of the second gas composition, optionally at the selected temperature. The method of the ninth aspect of the present invention may comprise features of the method of producing red lead as described in accordance with the fifth aspect of the present invention.

The method may comprise determining that Pb₂O₃ is desired, and the selection of one or more reaction parameters comprises selecting a first gas composition comprising carbon dioxide and an oxidising agent, preferably containing molecular oxygen. The selection of one or more reaction parameters optionally comprises selecting a second gas composition, the second gas composition comprising an oxidising agent, optionally comprising O₂, and optionally excluding carbon dioxide. The selection of one or more reaction parameters may comprise selecting a temperature at which the second gas composition will contact the reagents. The temperature is optionally at least 275° C. and optionally no more than 375° C. The method may comprise heating an organic lead salt in the presence of the first gas composition. The method may comprise subsequent heating in the presence of the second gas composition, optionally at the selected temperature. The method of the ninth aspect of the present invention may comprise features of the method of producing Pb₂O₃ as described in accordance with the seventh aspect of the present invention.

The method may comprise determining that more than one of alpha lead oxide, beta lead oxide, Pb₂O₃, red lead and lead metal is desired.

The method may comprise determining that a desired amount of a desired component is desired. For example, the method may comprise determining that beta lead oxide is desired and that at least 5 wt % lead metal is desired. The selection of one or more parameters may comprise selecting a gas composition comprising an oxidising agent, preferably containing molecular oxygen, optionally comprising air. The selection of one or more parameters may comprise selecting a temperature of at least 350° C. The gas composition may comprise an oxidising agent and an inert diluent. The method may comprise mixing a gas comprising an oxidising agent with an inert diluent. The method may comprise heating the organic lead salt in the presence of the gas composition at the selected temperature.

Those skilled in the art will realise that the chemical composition of the synthesised composition need not be identical to the intended chemical composition. Those skilled in the art will realise that, given the nature of chemical synthesis, the synthesised chemical composition may vary to a certain degree from that intended.

The organic lead salt may be as defined in relation to the method of the first aspect of the present invention.

In accordance with a tenth aspect of the present invention, there is provided a composition comprising one or more of alpha lead oxide, beta lead oxide, metallic lead, Pb₂O₃ and Pb₃O₄, the composition comprising particles comprising sub-particles, the sub-particles optionally having a mean greatest dimension of from 10 to 300 nm. The sub-particles may be in the form of projections.

The inventors have discovered that compositions comprising lead-based materials that may be of use in the battery industry have advantageous properties (in particular, relatively high surface area) if the composition comprises relatively large particles which comprise relatively small sub-particles, optionally in the form of projections. As mentioned above in relation to the second aspect of the invention, sub-particles are smaller than particles. Those skilled in the art will realise that not all sub-particles need be in the form of projections. Therefore, the particles may comprise sub-particles that are not in the form of projections. Therefore, at least some of the sub-particles may be in the form of projections.

The particles may be any shape. For example, the composition optionally comprises rod-like particles, with said projections on the rod-like particles. The rod-like particles optionally have a mean greatest dimension of from 0.2 μm to 20 μm. For example, the composition may comprise spherical or sub-spherical particles.

The dimensions of the particles and the sub-particles may be measured using any suitable method, such as scanning electron microscopy.

The mean greatest dimension of the sub-particles may be calculated using at least 30% by number of the sub-particles, optionally at least 40% by number of the sub-particles, optionally at least 50% by number of the sub-particles, optionally at least 60% by number of the sub-particles, optionally at least 70% by number of the sub-particles and optionally at least 80% by number of the sub-particles.

When determining the mean greatest dimension of the sub-particles, the sub-particle greatest dimensions may be determined using at least 30% by number of the particles, optionally using at least 40% by number of the particles, optionally using at least 50% by number of the particles, optionally using at least 60% by number of the particles, optionally using at least 70% by number of the particles, optionally using at least 80% by number of the particles and optionally using at least 90% by number of the particles.

When determining the mean greatest dimension of the sub-particles, the sub-particle greatest dimensions may be determined using at least 50% by mass of the composition, optionally using at least 60% by mass of the composition, optionally using at least 70% by mass of the composition, optionally using at least 80% by mass of the composition and optionally using at least 90% by mass of the composition.

Optionally, at least 20% by number of the particles of the composition are rod-like particles. Optionally, at least 40%, optionally at least 50%, optionally at least 60%, optionally at least 70%, optionally at least 80%, optionally at least 90% and optionally at least 95% by number of the particles of the composition are rod-like.

Optionally, of the rod-like particles, optionally at least 50% by number have a greatest dimension of from 0.2 μm to 20 μm, optionally at least 60%, optionally at least 70%, optionally at least 80% and optionally at least 90% by number have a greatest dimension of from 0.2 μm to 20 μm.

As mentioned above, the composition optionally comprises rod-like particles. The mean aspect ratio of the rod-like particles may be at least 1.5:1, optionally at least 2.0:1 and optionally at least 3.0:1. The mean aspect ratio of the rod-like particles may optionally be no more than 20:1, optionally no more than 15:1, optionally no more than 10:1, optionally no more than 7.5:1 and optionally no more than 5:1.

Optionally, of the rod-like particles, optionally at least 50% by number, optionally at least 60%, optionally at least 70%, optionally at least 80% and optionally at least 90% by number have an aspect ratio of at least 1.5:1, optionally at least 2.0:1 and optionally at least 3.0:1. Optionally at least 50% by number, optionally at least 60%, optionally at least 70%, optionally at least 80% and optionally at least 90% by number have an aspect ratio of no more than 20:1, optionally no more than 15:1, optionally no more than 10:1, optionally no more than 7.5:1 and optionally no more than 5:1.

The BET surface area of the composition, optionally as determined using nitrogen, optionally at 77 K, is optionally at least 1.0 m²/g, optionally at least 1.5 m²/g, optionally at least 2.0 m²/g, optionally at least 2.5 m²/g and optionally at least 3.0 m²/g. The BET surface area, optionally as determined using nitrogen, optionally at 77 K, is optionally no more than 10 m²/g, optionally no more than 8 m²/g, optionally no more than 6 m²/g and optionally no more than 5 m²/g.

The sub-particles may have a mean greatest dimension of at least 10 nm, optionally at least 15 nm, optionally at least 20 nm, optionally at least 25 nm, optionally at least 30 nm, optionally at least 40 nm and optionally at least 50 nm. The sub-particles may optionally have a mean greatest dimension of no more than 300 nm, optionally of no more than 250 nm, optionally of no more than 200 nm, optionally of no more than 150 nm and optionally of no more than 100 nm. The sub-particles may have mean greatest dimension of from 10 to 300 nm, optionally of from 15 nm to 200 nm, optionally of from 20 nm to 150 nm and optionally of from 50 to 150 nm. The sub-particles may be spherical or sub-spherical.

The pore volume of the composition, optionally as determined by BJH analysis, optionally from BET data obtained using nitrogen, optionally at 77 K, is optionally at least 0.0050 cm³g⁻¹, optionally at least 0.0060 cm³g⁻¹ and optionally at least 0.0070 cm³g⁻¹. The pore volume is optionally no more than 0.025 cm³g⁻¹, optionally no more than 0.020 cm³g⁻¹, optionally no more than 0.015 cm³g⁻¹, optionally no more than 0.010 cm³g⁻¹, optionally no more than 0.0080 cm³g⁻¹ and optionally no more than 0.0070 cm³g⁻¹.

The pore diameter of the composition as determined by adsorption measurement may optionally be at least 150 Å, optionally at least 175 Å, optionally at least 200 Å, optionally at least 225 Å, optionally at least 250 Å, optionally at least 275 Å and optionally at least 300 Å. The pore diameter as determined by adsorption measurement may optionally be no more than 400 Å, optionally no more than 375 Å, optionally no more than 350 Å, optionally no more than 325 Å, optionally no more than 300 Å, optionally no more than 275 Å, optionally no more than 250 Å, optionally no more than 225 Å and optionally no more than 200 Å.

The acid absorption of the composition may optionally be at least 200 mg acid per g of sample, optionally at least 220 mg acid per g of sample and optionally at least 240 mg acid per g of sample. The acid absorption may optionally be no more than 1000 mg acid per g of sample, optionally no more than 800 mg acid per g of sample, optionally no more than 600 mg acid per g of sample, optionally no more than 500 mg acid per g of sample, optionally no more than 400 mg acid per g of sample, optionally no more than 350 mg acid per g of sample, optionally no more than 300 mg acid per g of sample and optionally no more than 280 mg acid per g of sample. Acid absorption may be determined using sulphuric acid, for example, 16 wt % sulphuric acid.

The mean largest dimension of the sub-particles may optionally be no more than three times the mean smallest dimension of the sub-particles. For example, the mean “length” of the sub-particles may be no more than three times the mean “width” of the projections. The mean largest dimension of the sub-particles may optionally be no more than 2.5 times, optionally no more than 2.0 times and optionally no more than 1.5 times the mean smallest dimension of the sub-particles.

Throughout the entirety of this disclosure, if the sub-particles are projections, the projections may optionally be approximately spherical or part-spherical (e.g. hemispherical).

The composition may comprise particles with a lead metal-rich and oxide-poor core portion, and an oxide-rich outer portion. The wt % of lead metal in the core portion is optionally greater than the wt % of lead metal in the outer portion. The wt % of oxide in the core portion is optionally lower than the wt % of oxide in the outer portion. The inventors have discovered that some particles have a core that is rich in lead metal and has a low content of oxides of lead, and an outer portion that is rich in oxides of lead. Such an arrangement is favourable because the outer portion effectively protects the core portion from oxidation in the event that the composition is exposed to air. In relation to the composition of the outer portion, reference to “oxides of lead” includes all oxides of lead, including alpha lead oxide, beta lead oxide, red lead and Pb₂O₃.

The core portion may comprise at least 95 wt % lead metal, optionally at least 96 wt % lead metal and optionally at least 98 wt % lead metal. The core portion may be substantially devoid of oxides of lead.

The outer portion may comprise one or more of alpha lead oxide, beta lead oxide, red lead and Pb₂O₃.

The core portion may be spherical or sub-spherical.

The core portion may have a mean greatest dimension of at least 1 μm, optionally at least 2 μm, optionally at least 5 μm and optionally at least 10 μm. The core portion may optionally have a mean greatest dimension of no more than 100 μm, optionally no more than 80 μm, optionally no more than 60 μm, optionally no more than 50 μm, optionally no more than 40 μm and optionally no more than 30 μm.

The volume of the core portion is optionally greater than the volume of the outer portion. The volume of the core portion is optionally at least two times, optionally at least three times, optionally at least five times, optionally at least ten times, optionally at least fifteen times, optionally at least twenty times, optionally at least thirty times, optionally at least forty times, optionally at least fifty times and optionally at least one hundred times the volume of the outer portion.

Those skilled in the art will realise that the composition may comprise components other than alpha lead oxide, beta lead oxide, metallic lead, Pb₂O₃ and red lead. For example, the composition may comprise other oxides of lead (such as Pb₁₂O₁₉) and carbon. It is anticipated that these other components will form a minor proportion of the composition, such as no more than 5 wt % of the composition, optionally no more than 3 wt %, optionally no more than 2 wt %, optionally no more than 1 wt %, optionally no more than 0.5 wt % and optionally no more than 0.1 wt % of the composition. Therefore, optionally at least 95 wt %, optionally at least 97 wt %, optionally at least 98 wt %, optionally at least 99 wt %, optionally at least 99.5 wt % and optionally at least 99.9 wt % of the composition comprises one or more of alpha lead oxide, beta lead oxide, metallic lead, Pb₂O₃ and red lead.

The composition may comprise metallic lead. The composition may comprise alpha lead oxide. The composition may comprise beta lead oxide. The composition may comprise Pb₂O₃. The composition may comprise Pb₃O₄.

The composition may comprise more than one of alpha lead oxide, beta lead oxide, metallic lead, Pb₂O₃ and Pb₃O₄. For example, the composition may comprise metallic lead and one or both of alpha lead oxide and beta lead oxide. The composition may comprise alpha lead oxide and beta lead oxide.

The composition may, for example, comprise at least 1 wt % metallic lead, optionally at least 2 wt %, optionally at least 3 wt %, optionally at least 5 wt %, optionally at least 8 wt %, optionally at least 10 wt %, optionally at least 15 wt % and optionally at least 20 wt % metallic lead. The composition may, for example, comprise no more than 40 wt % metallic lead, optionally no more than 35 wt % metallic lead, optionally no more than 30 wt % metallic lead, optionally no more than 25 wt % metallic lead and optionally no more than 20 wt % metallic lead. It may be advantageous for the composition to comprise a certain amount of metallic lead, particularly if the composition also comprises alpha lead oxide and/or beta lead oxide.

The composition may essentially consist of one or more of alpha lead oxide, beta lead oxide, metallic lead, Pb₂O₃ and red lead.

The composition may comprise at least 98.0 wt % alpha lead oxide, optionally at least 98.5 wt %, optionally at least 99.0 wt % and optionally at least 99.5 wt % alpha lead oxide. The composition may comprise no more than 99.9 wt % alpha lead oxide, optionally no more than 99.8 wt % alpha lead oxide, optionally no more than 99.7 wt % alpha lead oxide, optionally no more than 99.6 wt % alpha lead oxide and optionally no more than 99.5 wt % alpha lead oxide.

The composition may optionally comprise at least 40 wt % alpha lead oxide, optionally at least 50 wt % alpha lead oxide, optionally at least 55 wt % alpha lead oxide, optionally at least 60 wt % alpha lead oxide, optionally at least 65 wt % alpha lead oxide, optionally at least 70 wt % alpha lead oxide and optionally at least 75 wt % alpha lead oxide.

The composition may optionally comprise no more than 95 wt % alpha lead oxide, optionally no more than 90 wt % alpha lead oxide, optionally no more than 85 wt % alpha lead oxide, optionally no more than 80 wt % alpha lead oxide, optionally no more than 75 wt % alpha lead oxide and optionally no more than 70 wt % alpha lead oxide. The applicant has discovered that is may be beneficial for the composition to comprise a reasonably large amount of alpha lead oxide, optionally in the presence of metallic lead.

The composition may optionally comprise at least 40 wt % beta lead oxide, optionally at least 50 wt % beta lead oxide, optionally at least 55 wt % beta lead oxide, optionally at least 60 wt % beta lead oxide, optionally at least 65 wt % beta lead oxide, optionally at least 70 wt % beta lead oxide and optionally at least 75 wt % beta lead oxide.

The composition may optionally comprise no more than 95 wt % beta lead oxide, optionally no more than 90 wt % beta lead oxide, optionally no more than 85 wt % beta lead oxide, optionally no more than 80 wt % beta lead oxide, optionally no more than 75 wt % beta lead oxide and optionally no more than 70 wt % beta lead oxide. The applicant has discovered that it may be beneficial for the composition to comprise a reasonably large amount of beta lead oxide, optionally in the presence of metallic lead.

The composition may optionally comprise at least 40 wt % total of beta lead oxide and alpha lead oxide, optionally at least 50 wt % total of beta lead oxide and alpha lead oxide, optionally at least 55 wt % total beta lead oxide and alpha lead oxide, optionally at least 60 wt % total beta lead oxide and alpha lead oxide, optionally at least 65 wt % total beta lead oxide and alpha lead oxide, optionally at least 70 wt % total beta lead oxide and alpha lead oxide, and optionally at least 75 wt % total beta lead oxide and alpha lead oxide.

The composition may optionally comprise no more than 95 wt % total beta lead oxide and alpha lead oxide, optionally no more than 90 wt % total beta lead oxide and alpha lead oxide, optionally no more than 85 wt % total beta lead oxide and alpha lead oxide, optionally no more than 80 wt % total beta lead oxide and alpha lead oxide, optionally no more than 75 wt % total beta lead oxide and alpha lead oxide, and optionally no more than 70 wt % total beta lead oxide and alpha lead oxide. The applicant has discovered that it may be beneficial for the composition to comprise a reasonably large amount of beta and alpha lead oxide, optionally in the presence of metallic lead.

The composition may comprise 50-80 wt % alpha lead oxide and 10-20 wt % metallic lead. The composition may comprise 60-80 wt % alpha lead oxide, optionally 70-80 wt % alpha lead oxide and optionally 75-80 wt % alpha lead oxide. The composition may comprise 10-15 wt % metallic lead or 15-20 wt % metallic lead.

The composition may comprise 50-80 wt % beta lead oxide and 10-20 wt % metallic lead. The composition may comprise 60-80 wt % beta lead oxide, optionally 70-80 wt % beta lead oxide and optionally 75-80 wt % beta lead oxide. The composition may comprise 10-15 wt % metallic lead or 15-20 wt % metallic lead.

The composition may comprise at least 98.0 wt % beta lead oxide, optionally at least 98.5 wt %, optionally at least 99.0 wt % and optionally at least 99.5 wt % beta lead oxide. The composition may comprise no more than 99.9 wt % beta lead oxide, optionally no more than 99.8 wt % beta lead oxide, optionally no more than 99.7 wt % beta lead oxide, optionally no more than 99.6 wt % beta lead oxide and optionally no more than 99.5 wt % beta lead oxide.

The composition may comprise at least 98.0 wt % Pb₃O₄, optionally at least 98.5 wt %, optionally at least 99.0 wt % and optionally at least 99.5 wt % Pb₃O₄. The composition may comprise no more than 99.9 wt % Pb₃O₄, optionally no more than 99.8 wt % Pb₃O₄, optionally no more than 99.7 wt % Pb₃O₄, optionally no more than 99.6 wt % Pb₃O₄ and optionally no more than 99.5 wt % Pb₃O₄.

The composition may comprise at least 40 wt % Pb₂O₃, optionally at least 50 wt % Pb₂O₃, optionally at least 60 wt % Pb₂O₃, optionally at least 70 wt % Pb₂O₃, optionally at least 80 wt % Pb₂O₃, optionally at least 90 wt % Pb₂O₃, optionally at least 95 wt % Pb₂O₃ and optionally at least 98 wt % Pb₂O₃.

The composition of the tenth aspect of the present invention may be made using the methods of the first, third, fifth, seventh and ninth aspects of the invention, and may therefore comprise one or more features of those aspects of the invention. Conversely, the methods of the first, third, fifth, seventh and ninth aspects of the invention may comprise one or more features of the composition of the tenth aspect of the invention. Furthermore, the composition of the tenth aspect of the present invention may comprise one or more features of the second, fourth, sixth and eighth aspects of the present invention. Conversely, the compositions of the second, fourth, sixth and eighth aspects of the present invention may comprise one or more features of the composition of the tenth aspect of the present invention.

In accordance with an eleventh aspect of the present invention, there is provided a composition comprising one or more of alpha lead oxide, beta lead oxide, metallic lead, Pb₂O; and Pb₃O₄, the composition comprising particles with a lead metal-rich and oxide-poor core portion, and an oxide-rich outer portion. The oxide-rich outer portion may be lead metal-poor. The inventors have discovered that some particles have a core that is rich in lead metal and has a low content of oxides of lead, and an outer portion that is rich in oxides of lead. Such an arrangement is favourable because the outer portion effectively protects the core portion from oxidation in the event that the composition is exposed to air. Without wishing to be bound by theory, it is anticipated that batteries made from such a composition may have an enhanced cycle life because the outer portion protects the core portion from sulfation.

The core portion may comprise at least 95 wt % lead metal, optionally at least 96 wt % lead metal and optionally at least 98 wt % lead metal. The core portion may be substantially devoid of lead oxides.

The outer portion may comprise one or more of alpha lead oxide, beta lead oxide, red lead and Pb₂O₃.

The core portion may be spherical or sub-spherical.

The core portion may optionally have a mean greatest dimension of at least 1 μm, optionally at least 2 μm, optionally at least 5 μm and optionally at least 10 μm. The core portion may optionally have a mean greatest dimension of no more than 100 μm, optionally no more than 80 μm, optionally no more than 60 μm, optionally no more than 50 μm, optionally no more than 40 μm and optionally no more than 30 μm.

Those skilled in the art will realise that the composition may comprise components other than alpha lead oxide, beta lead oxide, metallic lead, Pb₂O₃ and red lead. For example, the composition may comprise other oxides of lead (such as Pb₁₂O₁₉) and carbon. It is anticipated that these other components will form a minor proportion of the composition, such as no more than 5 wt % of the composition, optionally no more than 3 wt %, optionally no more than 2 wt %, optionally no more than 1 wt %, optionally no more than 0.5 wt % and optionally no more than 0.1 wt % of the composition. Therefore, optionally at least 95 wt %, optionally at least 97 wt %, optionally at least 98 wt %, optionally at least 99 wt %, optionally at least 99.5 wt % and optionally at least 99.9 wt % of the composition comprises one or more of alpha lead oxide, beta lead oxide, metallic lead, Pb₂O₃ and red lead.

The composition of the eleventh aspect of the present invention may be made using the methods of the first, third, fifth, seventh and ninth aspects of the present invention. The composition of the eleventh aspect of the present invention may comprise those features described above in relation to the compositions of the second, fourth, sixth, eighth and tenth aspects of the invention.

In some embodiments, the composition of the second, fourth, sixth, eighth, tenth and/or eleventh aspects of the present invention is processed into battery plates, for example, using methods that are well-known to those skilled in the art.

In accordance with a twelfth aspect of the present invention, there is provided a method of forming a lead acid battery plate comprising combining the composition of the second, fourth, sixth, eighth, tenth and/or eleventh aspects of the present invention with one or more battery paste additives and an acid to form a paste. Sulfuric acid will typically be used as the acid, which converts the lead oxide in the composition into PbSO₄. Suitable battery paste additives include those listed above and include metal compounds, insoluble carbon, barium sulphate and fibres. The paste may then be applied to a grid, typically a lead-alloy grid, and allowed to cure, forming a plate. The method of forming a lead-acid battery plate may be suitable for a thin plate pure lead (TPPL) battery.

In accordance with a thirteenth aspect of the present invention, there is provided a battery plate producible, or produced, by the method of the eleventh aspect of the present invention. The lead-acid battery plate may be suitable for a thin plate pure lead (TPPL) battery.

The battery plates may, in turn, be incorporated into a lead-acid battery. The battery plates may be incorporated into a lead-acid battery using known methods.

Therefore, in accordance with a fourteenth aspect of the present invention there is provided a lead-acid battery comprising one or more battery plates in accordance with the twelfth aspect of the present invention. The battery may be a thin plate pure lead (TPPL) battery.

The lead-acid battery of the fourteenth aspect of the present invention may comprise a battery casing in which one or more of the battery plates of the thirteenth aspect of the invention are located. The casing may contain a battery acid, such as sulfuric acid. Once the battery is assembled, the lead acid, e.g. PbSO₄, (and basic lead sulphates) in the battery plates is converted to PbO₂ on the positive plate and to metallic lead on the negative plate by applying a current in the cell formation stage.

It will, of course, be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows a schematic representation of an example of a method of making alpha lead oxide in accordance with a first embodiment of the invention;

FIG. 2A shows a low-magnification scanning electron microscopy image of an example of a composition comprising alpha lead oxide in accordance with the second and tenth aspects of the invention;

FIG. 2B shows a high-magnification scanning electron microscopy image of an example of a composition comprising alpha lead oxide in accordance with the second and tenth aspects of the invention;

FIG. 3 shows a schematic representation of an example of a method of making a composition comprising beta lead oxide in accordance with a further embodiment of the invention;

FIG. 4A shows a low-magnification scanning electron microscopy image of an example of a composition comprising beta lead oxide in accordance with the fourth and tenth aspects of the invention;

FIG. 4B shows a high-magnification scanning electron microscopy image of an example of a composition comprising beta lead oxide in accordance with the fourth and tenth aspects of the invention;

FIG. 5 shows a schematic representation of an example of a method of making red lead in accordance with a further embodiment of the invention;

FIG. 6A shows a low-magnification scanning electron microscopy image of an example of a composition comprising red lead in accordance with the sixth and tenth aspects of the invention;

FIG. 6B shows a high-magnification scanning electron microscopy image of an example of a composition comprising red lead in accordance with the sixth and tenth aspects of the invention;

FIG. 7 shows a schematic representation of an example of a method of making Pb₂O₃ in accordance with a further embodiment of the invention;

FIG. 8A shows a low-magnification scanning electron microscopy image of an example of a composition comprising Pb₂O₃ in accordance with the eighth and tenth aspects of the invention;

FIG. 8B shows a high-magnification scanning electron microscopy image of an example of a composition comprising Pb₂O₃ in accordance with the eighth and tenth aspects of the invention;

FIG. 9 shows a schematic representation of an example of a method of making a composition comprising a desired component in accordance with a further embodiment of the invention;

FIG. 10 shows a schematic representation of an example of a method of making a battery plate in accordance with yet another embodiment of the invention;

FIG. 11 is a simplified perspective view of a battery in accordance with an embodiment of the invention;

FIGS. 12A and 12B show low-magnification scanning electron microscopy images of an example of a core of a particle derived from a composition comprising alpha lead oxide in accordance with the second and tenth aspects of the invention;

FIG. 13 shows the metal lead content in a powdered sample of a lead oxide in accordance with the present invention when it is exposed to air over time, compared to conventional lead oxides;

FIGS. 14A and 14B shows a low-magnification and a high-magnification scanning electron microscopy image, respectively, of an example of a particle of a composition comprising a lead oxide in accordance with the tenth aspect of the invention.

### DETAILED DESCRIPTION

### Methods of Forming Compositions Comprising Alpha Lead Oxide.

A composition comprising alpha lead oxide was synthesised as follows. 30 g of lead citrate (Pb₃(C₆H₅O₇)₂·3H₂O) was placed in a 4 litre rotary furnace. The lead citrate was made as disclosed in WO2008/056125. Scanning electron microscopy shows that the lead citrate is elongate, with particle lengths of about 10-40 μm and particle widths of about 2-4 μm. X-ray diffraction was used to confirm that the lead citrate was indeed lead citrate. A mixture of air (18 litres/hour) and carbon dioxide (18-25 litres/hour) was passed over the lead citrate while the lead citrate was heated up to 350° C., and then while the lead citrate was heated at 350° C. for a known, first period of between 1 hour 45 minutes and 2 hours. After this first period, a flow of nitrogen (12 litres/hour) was passed over the contents of the rotary furnace for a known, second period of from 3 to 30 minutes. The rotary furnace was then cooled to room temperature, with nitrogen being passed through the rotary furnace (12 litres/hour). The rotary furnace was rotated at a rate of 20 rpm throughout. The resulting composition was then analysed using x-ray diffraction and acid dissolution techniques to determine the presence, and relative amounts, of various components within the composition, such as alpha lead oxide, beta lead oxide, red lead and lead metal as described above in relation to the method of the first aspect of the present invention.

Table 1 below shows how the composition varies with process conditions. Dwell time 1 refers to the time that the lead citrate was heated and exposed to air and carbon dioxide. Dwell time 2 refers to the time that the contents of the rotary furnace were heated in the presence of nitrogen. In the Comparative Examples CEx1-CEx4, a mixture of air and carbon dioxide is passed through the rotary furnace at all times.

TABLE 1
formation of composition comprising alpha lead oxide

| | | CO₂ | | | | | Alpha | | | | |
|---|---|---|---|---|---|---|---|---|---|---|---|
| | | flow | Dwell | Dwell | Beta PbO | | PbO | | Pb₃O₂CO₃ | Pb metal | |
| | | rate | time 1 | time 2 | Figures in parentheses - x-ray diffraction; | | | | | | |
| Example | VS no. | (L/hour) | (mins) | (mins) | figures not in parentheses - acid dissolution | | | | | | |
| 1 | 168 | 80 | 115 | 5 | — | (P) | — | (D) | (P) | 2.5 | (2) |
| 2 | 170 | 80 | 105 | 15 | — | (P) | — | (D) | (P) | 3 | (2) |
| 3 | 178 | 14 | 120 | 30 | 72.07 | (78) | 20.33 | (22) | (0) | 7.6 | (0) |
| 4 | 176 | 40 | 120 | 30 | 59.53 | (61) | 34.97 | (37) | (0) | 5.5 | (1) |
| 5 | 172 | 80 | 120 | 30 | 21.32 | (20) | 75.58 | (78) | (0) | 3.1 | (2) |
| 6 | 174 | 120 | 120 | 30 | 19.58 | (17) | 79.22 | (81) | (0) | 2.2 | (2) |
| 7 | 184 | 160 | 120 | 30 | 0 | (0) | 99.30 | (98) | (0) | 0.7 | (2) |
| 8 | 196 | 180 | 120 | 30 | 0 | (0) | 100 | (99) | (0) | 0 | (1) |

| | | | | | | | | | | |
|---|---|---|---|---|---|---|---|---|---|---|
| 9 | 186 | 200 | 120 | 30 | 0 | (0) | 97.80 | (99) | (0) | 0 (1), +2 |
| | | | | | | | | | | wt % C |
| CEx 1 | 160 | 12 | 120 | 0 | 59.34 | (69) | 26.66 | (31) | (0) | 13 (0), +1 |

| | | | | | | | | wt % red | |
|---|---|---|---|---|---|---|---|---|---|
| | | | | | | | | lead | |
| CEx 2 | 164 | 19 | 120 | 0 | (D) | (P) | (P) | 4.6 | (0) |
| CEx 3 | 162 | 24 | 120 | 0 | (P) | (D) | (P) | 5.6 | (—) |
| CEx 4 | 166 | 80 | 120 | 0 | (P) | (P) | (D) | 0.7 | (2) |

Note that Pb₃O₂CO₃ content was not measured using acid dissolution and carbon content was not measured using x-ray diffraction. In Table 1, “P” indicates “present” and “D” indicates “dominant”.

No carbon or red lead was found in any of the compositions of Examples 1-8. 2 wt % carbon was found in the composition of Example 9.

Examples 1 to 9 demonstrate that alpha lead oxide may be made by heating lead citrate in the presence of air and carbon dioxide, and then heating the reaction product in the presence of nitrogen.

Without wishing to be bound by theory, it is understood that the following reactions are taking place:

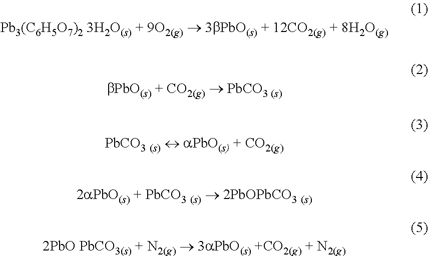

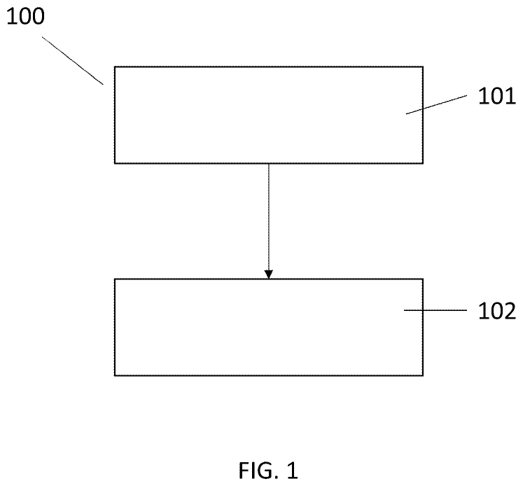

Referring to FIG. 1, and without wishing to be bound by theory, it is anticipated that the method 100 of forming alpha lead oxide from lead citrate comprises converting 101 lead citrate into 2PbOPbCO₃, and converting 102 2PbOPbCO₃ into alpha lead oxide. It is anticipated that oxygen in the air reacts with the lead citrate to form a lead oxide (likely beta lead oxide) which then reacts with the carbon dioxide to form lead carbonate. Heating of the lead carbonate causes the formation of alpha lead oxide, which reacts with the lead carbonate to form 2PbOPbCO₃. Heating of the 2PbOPbCO₃ in an inert gas (in this case, nitrogen) causes the formation of alpha lead oxide.

It seems to be beneficial to provide an excess of carbon dioxide in order to promote the formation of the lead carbonate. It is also beneficial for the heating of the PbOPbCO₃ in the inert gas to take place for a sufficiently long time to facilitate the formation of alpha lead oxide. It is anticipated that the use of the 250 litre/hour flow of carbon dioxide resulted in the formation of carbon due to the relatively low amounts of oxygen and relatively high amounts of carbon dioxide.

Examples 1-9 of Table 1 show that it is possible to produce a composition comprising a high percentage of alpha lead oxide. Furthermore, Examples 1-9 and Examples 3-9 in particular show that it is possible to control the relative amounts of alpha and beta lead oxide by controlling the relative amounts of air and carbon dioxide.

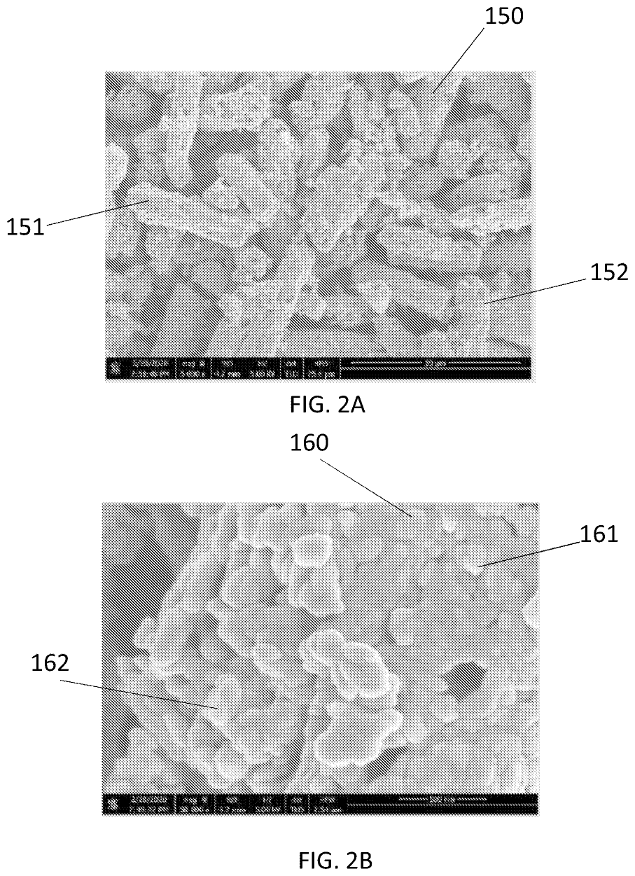

Scanning electron microscope images of the composition of Example 9 are shown in FIGS. 2A and 2B. The composition comprises larger, elongate particles 150, 151, 152 visible in FIG. 2A. Those particles have a similar shape and size to the particles of lead citrate used to make the alpha lead oxide. The particles have a mean length in excess of 5 μm and a mean width of about 1-2 μm. The surface of the particles appears to be roughened, with smaller sub-particles being visible on the surface of the particles. Small sub-particles 160, 161, 162 having a mean largest dimension of about 50-200 nm are visible.

### Methods of Forming Compositions Comprising Beta Lead Oxide.

A composition comprising beta lead oxide was synthesised as follows. 30 g of lead citrate (Pb₃(C₆H₅O₇)₂·3H₂O) was placed in a 4 litre rotary furnace. The lead citrate was made as disclosed in WO2008/056125. Scanning electron microscopy shows that the lead citrate is elongate, with particle lengths of about 10-40 microns and particle widths of about 2-4 μm. X-ray diffraction was used to confirm that the lead citrate was indeed lead citrate. A mixture of air (6-100 litres/hour) and nitrogen (12 litres/hour) was passed over the lead citrate while the lead citrate was heated up to 350° C., and then while the lead citrate was heated at 350° C. for 2 hours. The rotary furnace was then cooled to room temperature, with the same mixture of nitrogen and air being passed through the rotary furnace. The rotary furnace was rotated at a rate of 20 rpm throughout. The resulting composition was then analysed using x-ray diffraction and acid dissolution techniques to determine the presence, and relative amounts, of various components within the composition, such as alpha lead oxide, beta lead oxide, red lead and lead metal as described above.

Table 2 below shows how the composition varies with process conditions.

TABLE 2
formation of compositions comprising beta lead oxide

| | | | Air | | Alpha | | Pb | | Red |
|---|---|---|---|---|---|---|---|---|---|
| | | | flow | Beta PbO | PbO | | metal | | lead |
| | | Temp. | rate | Figures in parentheses - x-ray diffraction; | | | | | |
| Example | VS no. | (° C.) | (L/hour) | figures not in parentheses - acid dissolution | | | | | |
| 10 | 116(118) | 350 | 100 | 60.43 (96) | 1.26 | (2) | 33.55 | (2) | 3.5 |
| 11 | 118(120) | 350 | 50 | 60.38 (91) | 5.31 | (8) | 29.75 | (1) | 3.9 |
| 12 | 120(122) | 350 | 30 | 69.75 (91) | 6.13 | (8) | 19.75 | (1) | 3.6 |
| 13 | 136 | 350 | 24 | 77.43 (87) | 10.68 | (12) | 8 | (1) | 3.0 |
| 14 | 130 | 350 | 18 | 77.70 (86) | 12.65 | (14) | 5.95 | (0) | 3.7 |
| 15 | 132 | 350 | 12 | 82.81 (89) | 9.31 | (10) | 3.25 | (1) | 3.7 |
| 16 | 134 | 350 | 6 | 91.70 (93) | 6.90 | (7) | 0.6 | (0) | 0.8 |
| 17 | 138 | 300 | 24 | 91.19 (93) | 6.86 | (7) | 0.15 | (0) | 1.8 |
| 18 | 140 | 400 | 24 | 81.26 (91) | 8.04 | (9) | 10 | (1) | 0.7 |
| 19 | 144 | 350 | 24 | 82.24 (89) | 10.16 | (11) | 5.6 | (0) | 2.0 |
| 20 | 148 | 350 | 24 | 79.98 (93) | 5.16 | (6) | 8.1 | (1) | 5.9 |
| 21 | 150 | 350 | 15 | 82.53 (90) | 9.17 | (10) | 3.4 | (0) | 4.9 |
| 22 | 154 | 350 | 15 | 79.30 (89) | 8.02 | (9) | 9.8 | (1) | 1.1 |

In Example 19, there was no gas flow in the cooling stage i.e. after two hours of exposure to the mixture of air and nitrogen at 350° C. In Examples 20 and 21, nitrogen was omitted from the gas mixture, and as in Example 19 there was no gas flow in the cooling stage i.e. after two hours of exposure to air at 350° C. In Example 22, nitrogen was omitted from the gas mixture, but contrary to Examples 19-21 there was a 12 litres/hour flow of nitrogen in the cooling stage.

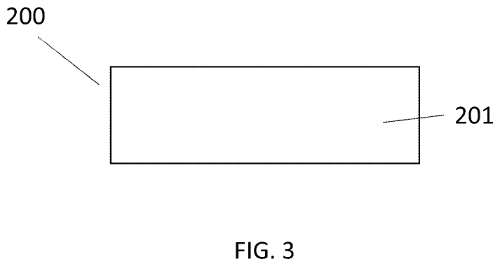

Examples 10 to 22 demonstrate that the controlled production of beta lead oxide may be achieved by heating lead citrate in a flow of air. Referring to FIG. 3, and without wishing to be bound by theory, it is anticipated that the method 200 of forming beta lead oxide from lead citrate comprises heating 201 lead citrate in the presence of an oxidising agent, in this case, oxygen in the air.

Examples 10 to 16 demonstrate that the use of high flow rates of air promotes the formation of beta lead oxide and lead metal, with some alpha lead oxide. As the amount of air decreases, the amount of beta lead oxide increases and the amount of lead metal decreases. Examples 10 to 16 demonstrate that it is possible to control the amount of lead metal in the composition by controlling the relative amounts of air and nitrogen.

Examples 13, 17 and 18 show that as the temperature at which the lead citrate is exposed to air and nitrogen is increased from 300° C. to 400° C., the amount of lead metal increases. Furthermore, scanning electron microscopy images show that the composition generated by heating to 300° C. comprises small sub-particles of about 50 μm size, whereas the composition generated by heating to 400° C. comprises larger sub-particles of a few hundred microns size.

Without wishing to be bound by theory, the expected reaction mechanism is shown below:

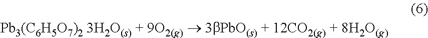

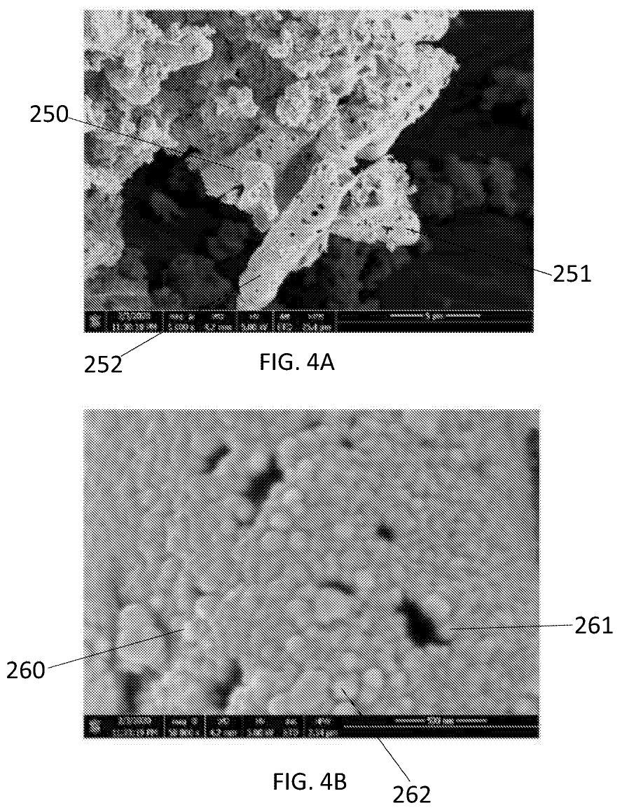

Scanning electron microscope images of the composition of Example 13 are shown in FIGS. 4A and 4B. The composition comprises larger, elongate particles 250, 251, 252 visible in FIG. 4A. Those particles have a similar shape and size to the particles of lead citrate used to make the alpha lead oxide. The particles have a mean length in excess of 5 μm and a mean width of about 1-2 μm. The surface of the particles appears to be roughened, with smaller sub-particles being visible on the surface of the particles. Small sub-particles 260, 261, 262 having a mean largest dimension of about 50-200 nm are visible.

### Methods of Forming Compositions Comprising Red Lead.

A composition comprising red lead was synthesised as follows. 30 g of lead citrate (Pb₃(C₆H₅O₇)₂·3H₂O) was placed in a 4 litre rotary furnace. The lead citrate was made as disclosed in WO2008/056125. Scanning electron microscopy shows that the lead citrate is elongate, with particle lengths of about 10-40 μm and particle widths of about 2-4 μm. X-ray diffraction was used to confirm that the lead citrate was indeed lead citrate. A mixture of air (18 litres/hour) and carbon dioxide (200 litres/hour) was passed over the lead citrate while the lead citrate was heated to 350° C., and then while the lead citrate was heated at 350° C. for two hours. After this first period, a flow of air (200 litres/hour) was passed over the contents of the rotary furnace for a known, second period of 30 or 60 minutes. The rotary furnace was then cooled to room temperature, with air being passed through the rotary furnace (200 litres/hour). The rotary furnace was rotated at a rate of 20 rpm throughout. The resulting composition was then analysed using x-ray diffraction and acid dissolution techniques to determine the presence, and relative amounts, of various components within the composition, such as alpha lead oxide, beta lead oxide, red lead and lead metal as described above.

Table 3 below shows how the composition varies with process conditions. Dwell time 2 is the duration of heating in the flow of air. Dwell temp. is the temperature at which the product is heated in the flow of air.

TABLE 3
formation of compositions comprising red lead

| | | | | | Alpha | | | Red | | Pb | |
|---|---|---|---|---|---|---|---|---|---|---|---|
| | | Dwell | Dwell | Beta PbO | PbO | Pb₂O₃ | | lead | | metal | |
| | | time 2 | temp | Figures in parentheses - x-ray diffraction; | | | | | | | |
| Example | VS no. | (mins) | (° C.) | figures not in parentheses - acid dissolution | | | | | | | |
| 23 | 180 | 30 | 350 | 0 (0) | 61.60 (62) | 37.8 | (38) | 0 | (0) | 0.65 | (0) |
| 24 | 188 | 60 | 350 | 0 (0) | 48.00 (48) | 35 | (35) | 16 | (16) | 0.00 | (1) |
| 25 | 190 | 60 | 370 | 0 (0) | 30.60 (30) | 0 | (0) | 69.4 | (68) | 0 | (2) |
| 26 | 192 | 60 | 390 | 0 (0) | 24.00 (24) | 0 | (0) | 76 | (76) | 0 | (0) |
| 27 | 194 | 60 | 410 | 0 (0) | 0 (0) | 0 | (0) | 100 | (100) | 0 | (0) |

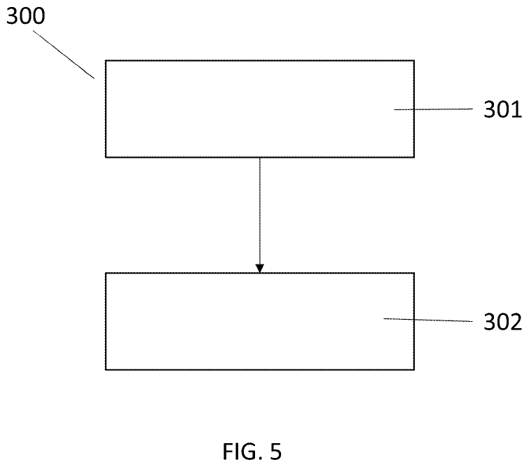

Examples 23 to 27 demonstrate that it is possible to make red lead and compositions with a high percentage of red lead by heating lead citrate in a flow of air and carbon dioxide, and then heating the reaction product in a flow of air. The use of higher temperatures during the heating in air promote the formation of red lead. Referring to FIG. 5, and without wishing to be bound by theory, it is anticipated that the method 300 of forming red lead from lead citrate comprises converting 301 lead citrate into PbOPbCO₃, and converting 302 PbOPbCO₃ into red lead.

Without wishing to be bound by theory, it is believed that the following reactions are occurring.

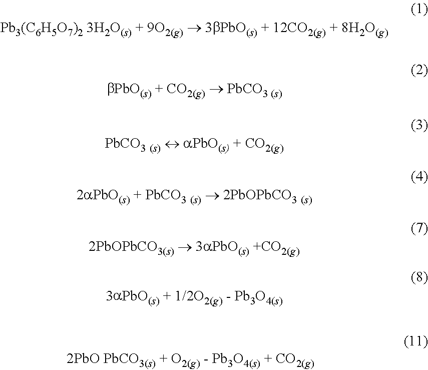

Converting 301 lead citrate into PbOPbCO₃ comprises heating the lead citrate to form beta lead oxide, which reacts with carbon dioxide to form lead carbonate. The lead carbonate decomposes on heating to form alpha lead oxide, which reacts with lead carbonate to form PbOPbCO₃. Heating of the PbOPbCO₃ in a stream of air causes the formation of alpha lead oxide, which reacts with oxygen to form red lead.

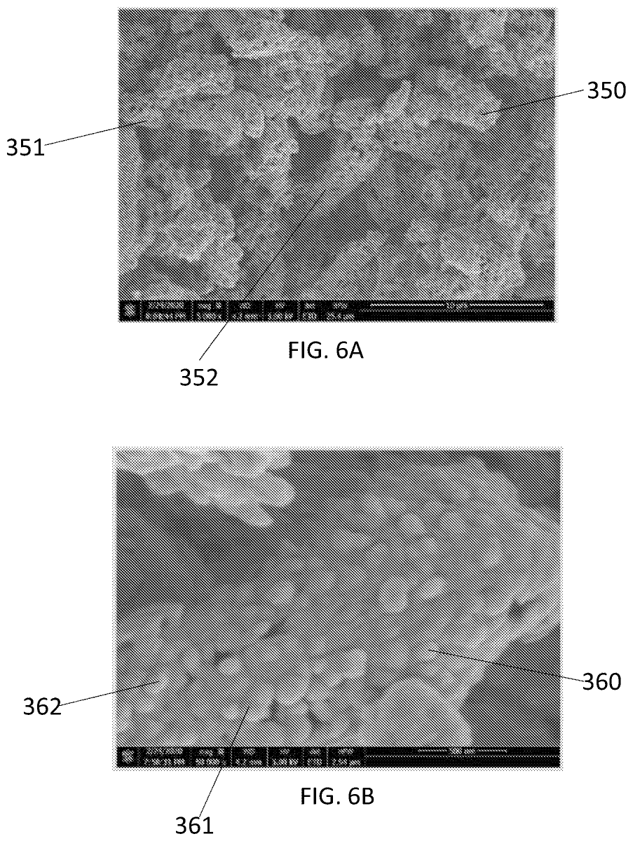

Scanning electron microscope images of the composition of Example 27 are shown in FIGS. 6A and 6B. The composition comprises larger, elongate particles 350, 351, 352 visible in FIG. 6A. Those particles have a similar shape and size to the particles of lead citrate used to make the alpha lead oxide. The particles have a mean length in excess of 5 μm and a mean width of about 1-2 μm. The surface of the particles appears to be roughened, with smaller sub-particles being visible on the surface of the particles. Small sub-particles 360, 361, 362 having a mean largest dimension of about 50-100 nm are visible.

Methods of Forming Compositions Comprising Pb₂O₃

A composition comprising Pb₂O₃ was synthesised as follows. 30 g of lead citrate (Pb₃(C₆H₅O₇)₂·3H₂O) was placed in a 4 litre rotary furnace. The lead citrate was made as disclosed in WO2008/056125. Scanning electron microscopy shows that the lead citrate is elongate, with particle lengths of about 10-40 μm and particle widths of about 2-4 μm. X-ray diffraction was used to confirm that the lead citrate was indeed lead citrate. A mixture of air (18 litres/hour) and carbon dioxide (200 litres/hour) was passed over the lead citrate while the lead citrate was heated up to 350° C., and then while the lead citrate was heated at 350° C. for two hours. After this first period, a flow of air (between 30 and 200 litres/hour) was passed over the contents of the rotary furnace for a known, second period of 30 to 120 minutes at a temperature of 300° C. or 350° C. The rotary furnace was then cooled to room temperature, with air being passed through the rotary furnace (200 litres/hour). The rotary furnace was rotated at a rate of 20 rpm throughout. The resulting composition was then analysed using x-ray diffraction and acid dissolution techniques to determine the presence, and relative amounts, of various components within the composition, such as alpha lead oxide, beta lead oxide, red lead and lead metal as explained above.

Table 4 shows how the composition varies with processing conditions.

TABLE 4
formation of compositions comprising Pb₂O₃

| | Air | | | Metal | | | | | | |
|---|---|---|---|---|---|---|---|---|---|---|
| | flow | | Dwell | lead | Alpha PbO | | Pb₂O₃ | | Red Lead | |
| | rate | Temp. | time 2 | Figures in parentheses - x-ray diffraction; | | | | | | |
| Example | (L/hour) | (° C.) | (mins) | figures not in parentheses - acid dissolution | | | | | | |
| 28 | 200 | 350 | 30 | | 68 | (68) | 32 | (32) | | |
| 29 | 200 | 350 | 60 | (1) | 48.5 | (48) | 35.4 | (35) | 16.2 | (16) |
| 30 | 100 | 350 | 30 | | 40 | (40) | 60 | (60) | | |
| 31 | 30 | 350 | 30 | (1) | 46.46 | (46) | 53.53 | (53) | | |
| 32 | 100 | 350 | 60 | | 25 | (25) | 29 | (29) | 46 | (46) |
| 33 | 100 | 330 | 60 | | 41 | (41) | 59 | (59) | | |
| 34 | 100 | 330 | 120 | | 33 | (33) | 52 | (52) | 15 | (15) |

| | | | | | | | | |
|---|---|---|---|---|---|---|---|---|
| 35 | 100 | 300 | 120 | (1) | 36 | (36) | 63.63 | (63) |
| 36 | 100 | 300 | 240 | | 31 | (31) | 69 | (69) |

The temperature referred to in Table 4 is the temperature at which the contents of the rotary furnace are exposed to air. The duration referred to in Table 4 is the duration for which the contents of the rotary furnace are exposed to air.

Examples 28 to 36 demonstrate that it is possible to make compositions with a high percentage of Pb₂O₃ by heating lead citrate in a flow of air and carbon dioxide, and then heating the reaction product in a flow of air, preferably at a relatively low temperature (in this case, 300° C. seems to be preferred). The use of higher temperatures during the heating in air promotes the formation of red lead, whereas the use of lower temperatures during the heating in air promotes the formation of Pb₂O₃.

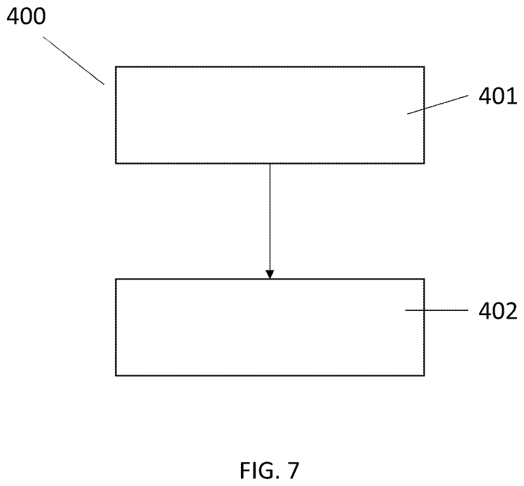

Referring to FIG. 7, and without wishing to be bound by theory, it is anticipated that the method 400 of forming red lead from lead citrate comprises converting 401 lead citrate into PbOPbCO₃, and converting 402 PbOPbCO₃ into Pb₂O₃. Converting 401 lead citrate into PbOPbCO₃ comprises heating the lead citrate to form beta lead oxide, which reacts with carbon dioxide to form lead carbonate. The lead carbonate decomposes on heating to form alpha lead oxide, which reacts with lead carbonate to form PbOPbCO₃. Heating of the PbOPbCO₃ in a stream of air causes the formation of alpha lead oxide, which reacts with oxygen to form Pb₂O₃.

Without wishing to be bound by theory, it is believed that the following reactions are occurring.

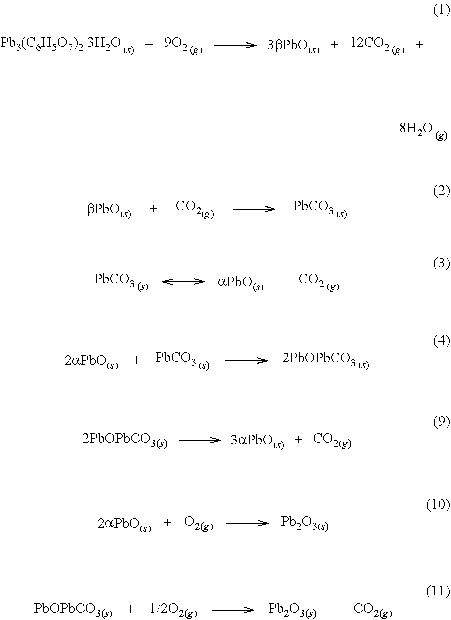

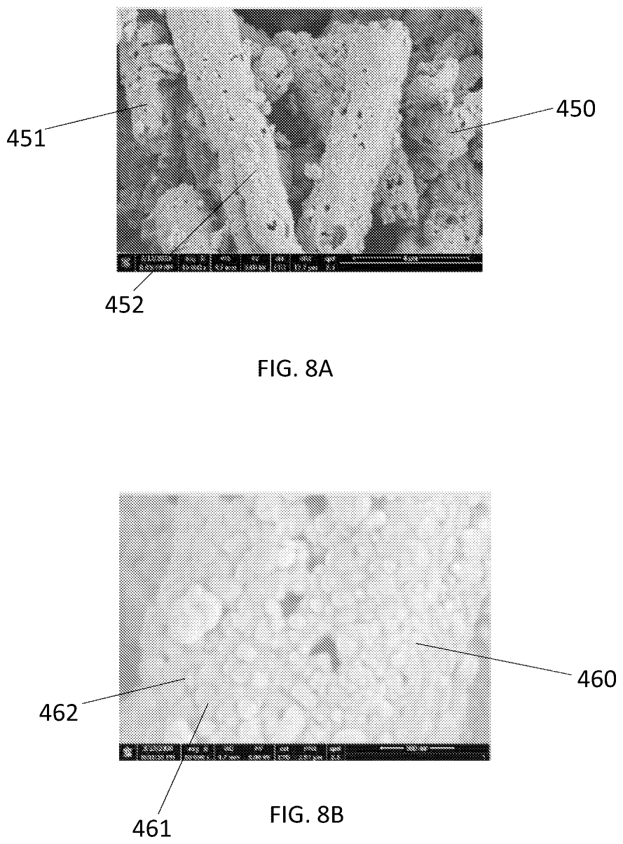

Scanning electron microscope images of the composition of Example 36 are shown in FIGS. 8A and 8B. The composition comprises larger, elongate particles 450, 451, 452 visible in FIG. 6A. Those particles have a similar shape and size to the particles of lead citrate used to make the alpha lead oxide. The particles have a mean length in excess of 5 μm and a mean width of about 1-2 μm. The surface of the particles appears to be roughened, with smaller sub-particles being visible on the surface of the particles. Small sub-particles 460, 461, 462 having a mean largest dimension of about 50-100 nm are visible.

Compositions comprising alpha lead oxide, beta lead oxide, red lead and Pb₂O₃ in accordance with the present invention were investigated to determine their BET surface area, pore volume and pore diameter. These were determined using sample sizes of about 0.55-0.60 g, a bath temperature of 77 K and N₂ as the analytical adsorptive.

TABLE 5
some characteristics of compositions in
accordance with the present invention

| | | | Pore diameter |
|---|---|---|---|
| | BET surface | Pore volume | (Å) (based on |
| Sample | area (m²g⁻¹) | (cm³g⁻¹) | adsorption) |
| Alpha lead | 2.17 | 0.00734 | 274 |
| oxide | | | |
| Beta lead oxide | 2.67 | 0.0127 | 267 |
| Red lead | 2.58 | 0.0109 | 299 |
| Pb₂O₃ | 3.31 | 0.0139 | 240 |

The structure of beta lead oxide in accordance with the fourth, tenth and eleventh aspects of the present invention was investigated. Sticky carbon tape was covered relatively evenly with beta lead oxide in accordance with the present invention and conventional ball mill lead oxide. The powdered lead oxides were then pressed to embed the powders firmly into the tape. 1 drop of 1 wt % acetic acid solution was added to slowly dissolve the PbO. After 30 sec., excess solution was removed with dry paper. This process of wetting with acetic acid and removing excess solution was repeated four times. The remaining material was then rinsed four times with a drop of distilled water.

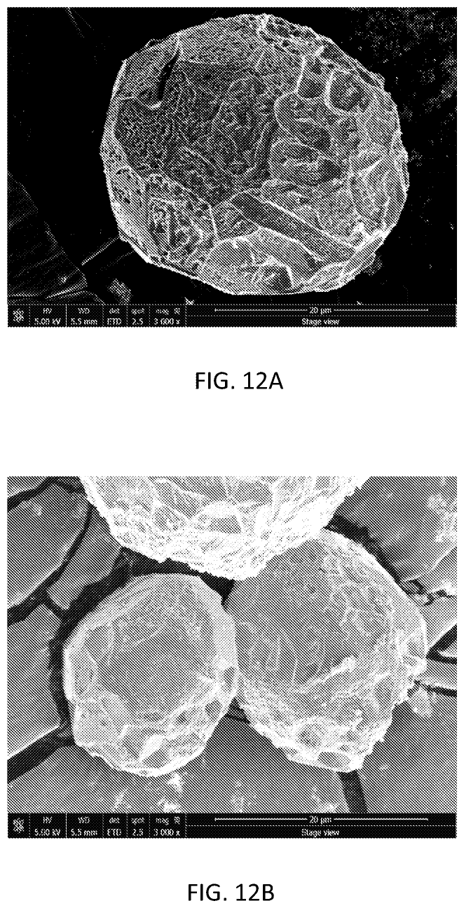

FIGS. 12A and 12B show the particles that remain after the particles were exposed to acetic acid. The remaining particles are essentially spherical or sub-spherical (essentially, resembling a sphere), and are about 15-30 μm in diameter. Each of the remaining particles is essentially a core of the original particle. Given that a 1 wt % acetic acid solution would only dissolve PbO and not Pb, the core is essentially made of lead metal. The outer region comprising lead oxide has been dissolved by the acetic acid. This provides evidence of a lead oxide structure comprising a lead metal core covered by an outer region of lead oxide. Such a structure is beneficial because the lead oxide protects the inner lead metal from oxidation in the event that the composition is exposed to a potentially-oxidising environment (such as the air).

One of the main properties measured by battery manufacturers to determine the performances of a lead oxide is acid absorption. The acid absorption characteristics of the materials described above in relation to FIGS. 12A and 12B were investigated, and compared to conventional ball mill and Barton pot lead oxides. A 22 g (20 ml) solution of 16 wt % sulfuric acid was prepared and cooled to room temperature. 10 g of lead oxide was then added under stirring at 350 rpm in an insulated vessel. The suspension was left to react for 20 min before analysis. H₂SO₄ absorption was determined by titration of unreacted H₂SO₄ with NaOH, it was also correlated with temperature rise in the suspension during reaction. The mass percentage of lead oxide reacted was also determined.

TABLE 6
acid absorption characteristics of alpha and
beta leady oxides of the present invention

| | | | Beta lead | Alpha lead |
|---|---|---|---|---|
| | | | oxide of the | oxide of the |
| | | | present | present |
| | Barton Pot | Ball Mill | invention | invention |
| Acid | 150.8 | 184.9 | 232.6 | 258.9 |
| absorption (mg | | | | |
| H₂SO₄/g | | | | |
| sample) | | | | |
| Temperature | 11.35 | 12.5 | 17.1 | 17.7 |
| increase (° C.) | | | | |
| Mass | 34% | 42% | 52.9% | 58.9% |
| percentage of | | | | |
| leady oxide | | | | |
| reacted (wt %) | | | | |

The data of Table 6 show that the acid absorption characteristics of the alpha and beta lead oxides of the present invention are superior to conventional Barton pot and ball mill lead oxides. Furthermore, the mass percentage of the lead oxide reacted is far greater for the alpha and beta lead oxides of the present invention than for the conventional lead oxides.

The surface area and pore volume were measured for the materials studied in Table 6, and are shown in Table 7.

TABLE 7
surface area and pore volume for alpha and
beta leady oxides of the present invention

| | Barton pot | Ball mill | Beta PbO | Alpha PbO |
|---|---|---|---|---|
| Surface area | 0.44 | 1.34 | 1.08 | 1.96 |
| BET (m² · g⁻¹) | | | | |
| Pore volume | 0.00175 | 0.004478 | 0.00620 | 0.011 |
| (cm³ · g⁻¹) | | | | |

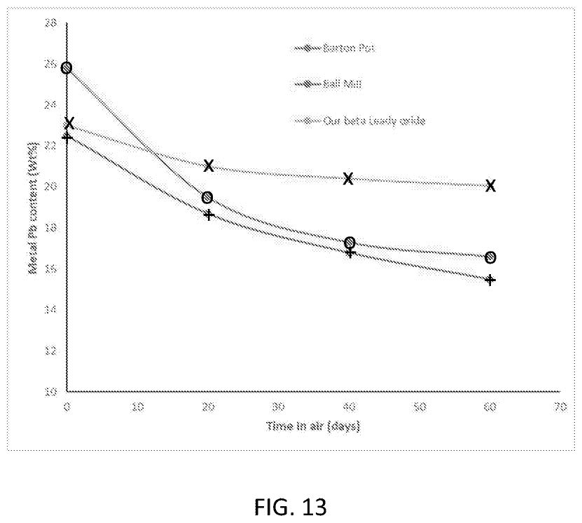

The stability of the metallic lead in the materials described above in relation to FIGS. 12A and 12B were investigated. The metallic lead content of the lead oxide in accordance with the present invention (x) was compared to known Barton pot (o) and ball mill (+) lead oxides. Metallic lead content was determined by reaction with an acid or alkali. FIG. 13 shows how the metallic lead content varies with time. It is clear from FIG. 13 that there is a far lower rate of loss of metallic lead for the lead oxide of the present invention than for the conventional lead oxides.

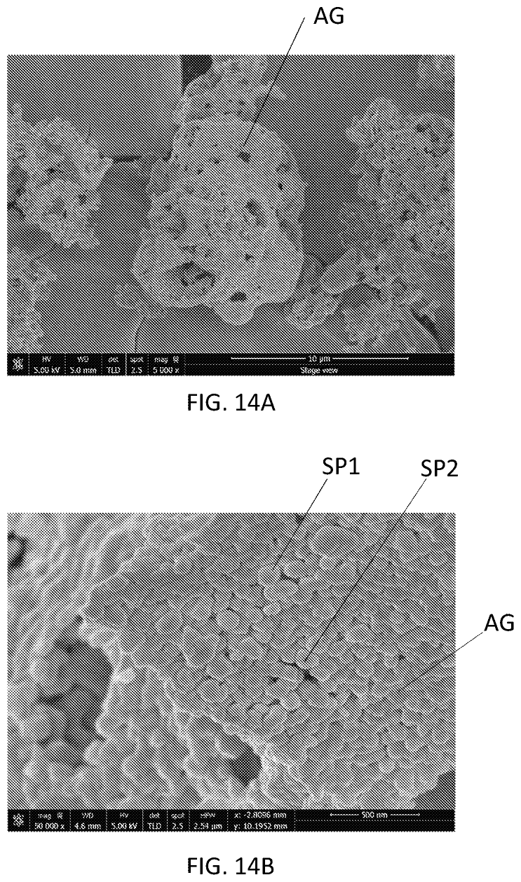

Scanning electron microscope images of an example of a composition in accordance with the tenth aspect of the present invention are shown in FIGS. 14A and 14B. FIG. 14A is a low magnification image, which shows an agglomerated particle AG, which has a network of channels and pores therein. The particle AG has an ill-defined amorphous shape. As shown in FIG. 14B, the particles comprise multiple sub-particles, two of which are labelled SP1 and SP2. The sub-particles have a mean greatest dimension of about 50-100 nm.

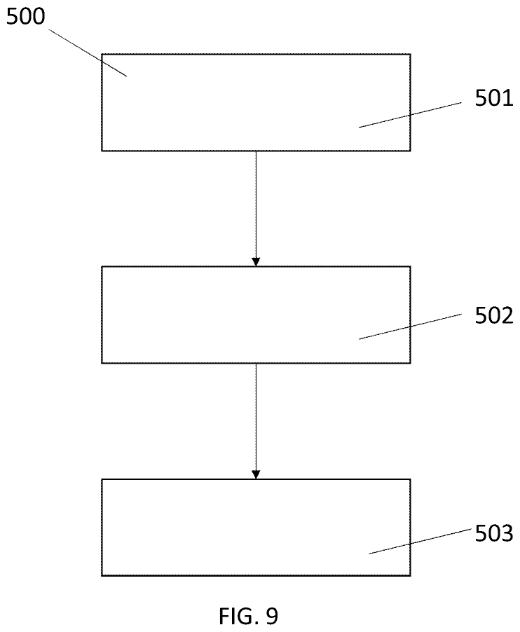

An example of a method in accordance with an embodiment of the ninth aspect of the present invention will be described with reference to FIG. 9. The method is denoted generally by reference numeral 500, and is a method of producing a composition comprising a desired one or more of alpha lead oxide, beta lead oxide, Pb₂O₃, red lead and lead metal. The method 500 comprises determining 501 which of alpha lead oxide, beta lead oxide, Pb₂O₃, red lead and lead metal is or are desired in the composition. In this particular example, we determine 501 that a composition comprising red lead is desired. The method 500 comprises, based on said determination, selecting 502 one or more reaction parameters from the list consisting of one or more heating temperatures, one or more heating durations and one or more gas compositions. As has been demonstrated above, in order to make a composition comprising red lead, we heat lead citrate in a mixture of air and carbon dioxide, and then heat the resulting composition in a stream of air at a temperature of 400° C. In this connection, we therefore select 502 a first gas composition comprising carbon dioxide and air in which the lead citrate will be heated. We also select a second gas composition comprising air for subsequent heating at 400° C., the second gas composition comprising air. We then heat the lead citrate at 350° C. for two hours in a mixture of air and carbon dioxide, and then heat the resulting composition in air for an hour at 400° C., thereby forming a composition comprising red lead.

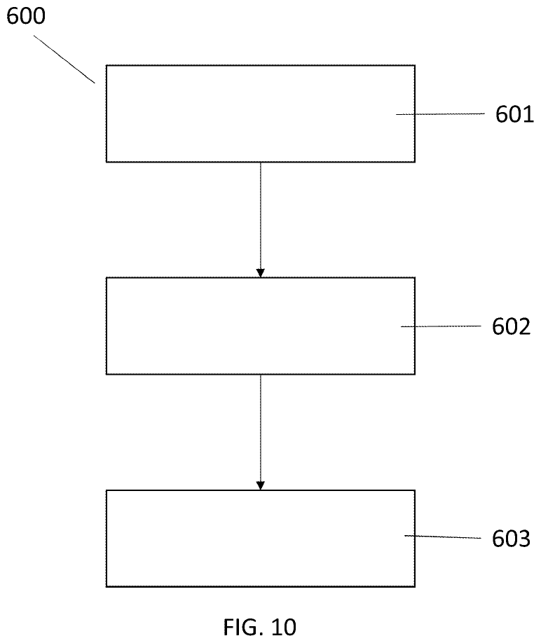

An example of a method of making a battery plate in accordance with yet another embodiment of the invention will now be described with reference to FIG. 10. The method of forming lead acid battery plates is denoted generally by reference numeral 600. The method 600 comprises combining 601 a composition of the second, fourth, sixth and/or eighth aspects of the present invention with one or more battery plate additives and an acid to form a paste. Sulfuric acid will typically be used as the acid, which converts the lead oxide in the composition into PbSO₄. Suitable battery plate additives include those listed above and include metal compounds, insoluble carbon, barium sulphate and fibres, such as lignin-based fibres. The paste may then be applied 602 to a grid, typically a lead-alloy grid, and allowed to cure 603 to form a lead acid battery plate.

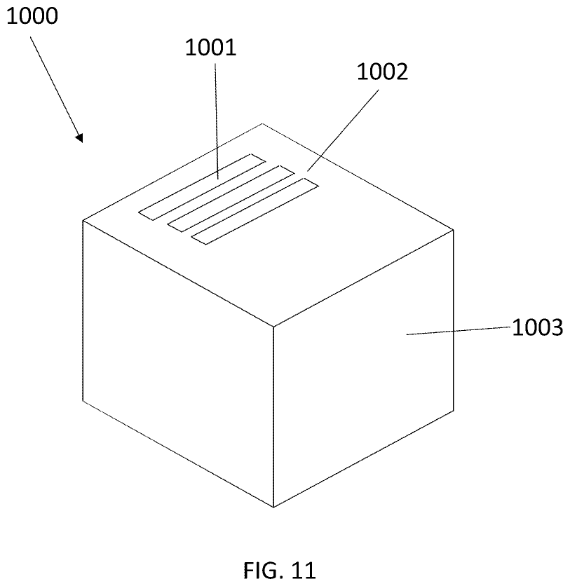

FIG. 11 is a simplified exploded perspective view of a battery in accordance with an embodiment of the invention. The battery is denoted generally by reference numeral 1000 and comprises a plurality of battery plates only one of which 1001 is labelled. The battery plate 1001 is a battery plate made as describe above in relation to the method of FIG. 10. The battery plates 1001 are located in a plastics casing 1003. Sulphuric acid is provided in the casing 1003 and is in contact with the battery plates 1001.

Many of the methods mentioned above comprise an oxidation process, which is sometimes followed by a thermal decomposition process, depending on the method. The oxidation processes are generally exothermic, while the thermal decomposition processes are generally endothermic. The net energy required is the difference between heat absorbed in the endothermic process and the heat produced by the exothermic process, thus the energy required for the process may be relatively low, may be neutral but sometimes, net energy is available from the process.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

In some of the examples above nitrogen is used as an inert gas. Those skilled in the art will realise that other inert gases may be used, such as any of the noble gases.

The examples above show how air is used to provide molecular oxygen as an oxidising agent. Those skilled in the art will realise that oxidising agents other than molecular oxygen may be used. Furthermore, the molecular oxygen need not be provided in air.

The inventors have demonstrated that the compositions in accordance with the present invention have been made using the methods described herein. Those skilled in the art will realise that other methods may be used to arrive at the composition in accordance with the present invention.

The examples above demonstrate the use of lead citrate as a starting material. Those skilled in the art will realise that other organic lead salts may be used. In particular, those skilled in the art will realise that other lead carboxylates may be used.

The examples above use lead citrate having a particulate size and shape. Those skilled in the art will realise that lead citrate having a different shape and size may be used.

The methods exemplified above use a rotary furnace. Those skilled in the art will realise that other furnaces or reaction vessels may be used.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1-18. (canceled)

19. A method of making a composition comprising alpha lead (II) oxide, the method comprising:
converting lead citrate into lead carbonate by heating the lead citrate in the presence of an oxidising gas and carbon dioxide, converting the lead carbonate into PbOPbCO₃ by heating the lead carbonate; and
heating said PbOPbCO₃ in a substantially inert atmosphere.

20. A method according to claim 19, wherein the PbOPbCO₃ is heated in the substantially inert atmosphere for at least 5 minutes.

21. A method according to claim 19, wherein the PbOPbCO₃ is heated in the substantially inert atmosphere at a temperature of from 300° C. to 400° C.

22. A method according to claim 21, wherein the oxidising gas comprises molecular oxygen, and the molar ratio of carbon dioxide to molecular oxygen is at least 15:1.

23. (canceled)

24. A method of making a composition comprising beta lead oxide, the method comprising heating lead citrate in a flow of a gas comprising an oxidising agent, the method comprising mixing a precursor gas comprising the oxidising agent with an inert diluent gas to provide the gas comprising the oxidising agent, wherein the molar ratio of the inert diluent gas to the precursor gas is at least 1:10, and no more than 3:1.

25. A method according to claim 24, wherein the lead citrate is heated while exposed to the flow of gas to a temperature of at least 250° C. and no more than 450° C.

26. A method according to claim 25, wherein the lead citrate is heated while exposed to the flow of gas to a temperature of from 275° C. to 375° C. for a duration of from 60-180 minutes.

27. A method according to claim 24, wherein the oxidising agent is in the form of a gaseous oxidising agent, and the gas comprising the oxidising agent comprises at least 5 wt % oxidising agent, and no more than 14 wt % oxidising agent.

28. (canceled)

29. A method of making a composition comprising red lead, the method comprising:
converting lead citrate into lead carbonate by heating the lead citrate in the presence of an oxidising gas and carbon dioxide, converting the lead carbonate into PbOPbCO₃; and
converting PbOPbCO₃ into alpha lead oxide and converting alpha lead oxide into red lead, by heating the PbOPbCO₃ in the presence of a flow of gas comprising an oxidiser at a temperature of at least 350° C.

30-32. (canceled)

33. A method according to claim 29 wherein converting PbOPbCO₃ into alpha lead oxide comprises heating PbOPbCO₃ in the presence of a flow of gas comprising an oxidiser at a temperature of at least 375° C.

34. (canceled)

35. A method of making a composition comprising Pb₂O₃, the method comprising:
converting lead citrate into lead carbonate by heating the lead citrate in the presence of an oxidising gas and carbon dioxide, converting the lead carbonate into PbOPbCO₃; and
converting PbOPbCO₃ into alpha lead oxide and converting alpha lead oxide into Pb₂O₃, by heating the PbOPbCO₃ in the presence of a flow of gas comprising an oxidiser at a temperature of no more than 325° C.

36-41. (canceled)

42. A method according to claim 19, wherein the particles of lead citrate are rod-like and have a mean greatest dimension of at least 0.5 μm, and no more than 20 μm.

43-45. (canceled)

46. A composition producible, or produced by, the method of claim 19, comprising one or more of alpha lead oxide, beta lead oxide, metallic lead, Pb₂O₃ and Pb₃O₄, the composition comprising particles comprising sub-particles in the form of projections, the sub-particles having a mean greatest dimension of from 10 to 300 nm, and the composition having an acid absorption, determined using sulphuric acid, of at least 200 mg acid per g of sample.

47. A composition according to claim 46, wherein the composition comprises one or more of alpha beta oxide and beta lead oxide.

48. A composition according to claim 46, comprising metallic lead.

49. A composition according to claim 48, comprising at least 5 wt % metallic lead.

50. A composition according to claim 48 comprising no more than 40 wt % metallic lead.

51. A composition according to claim 46, wherein the composition comprises rod-like particles.

52. A composition according to claim 51 wherein the rod-like particles have a greatest dimension of from 0.2 μm to 20 μm.

53. A composition according to claim 51, wherein at least 50% by number of the particles of the composition are rod-like.

54. A composition according to claim 51, wherein, of the rod-like particles, at least 50% by number have a greatest dimension of from 0.2 μm to 20 μm.

55. A composition according to claim 51, wherein, of the rod-like particles, at least 50% by number have an aspect ratio of at least 1.5:1, and optionally have an aspect ratio of no more than 20:1.

56. A composition according to claim 46, wherein the sub-particles have a mean greatest dimension of at least 20 nm.

57. A composition according to claim 46, wherein the sub-particles have a mean greatest dimension of no more than 200 nm.

58. A composition according to claim 46, wherein the sub-particles have a mean greatest dimension of from 50 to 150 nm.

59. A composition according to claim 46, wherein at least 95 wt % of the composition comprises one or more of alpha lead oxide, beta lead oxide, metallic lead, Pb₂O₃ and red lead.

60. A composition according to claim 59, wherein at least 98 wt % of the composition comprises one or more of alpha lead oxide, beta lead oxide, metallic lead, Pb₂O₃ and red lead.

61. A composition according to claim 46, wherein the BET surface area of the composition as determined using nitrogen is at least 1.0 m²/g.

62. A composition according to claim 61, wherein the BET surface area of the composition is at least 2.5 m²/g.

63. A composition according to claim 46, comprising particles comprising a lead metal-rich and oxide-poor core portion, and an oxide-rich outer portion, the core portion optionally being spherical or sub-spherical.

64. A method of forming a lead-acid battery plate comprising combining the composition of claim 46 with one or more battery plate additives and an acid to form a paste.

65. A lead-acid battery plate producible, or produced, by the method of claim 64.

66. A lead-acid battery comprising one or more battery plates in accordance with claim 65.
